(19) United States
(12) Patent Application Publication
(10) Pub. No.: US 2024/0351189 A1
(43) Pub. Date: Oct. 24, 2024

(54) CONTROL SYSTEM AND CONTROL METHOD

(71) Applicant: TOYOTA JIDOSHA KABUSHIKI KAISHA, Toyota-shi (JP)

(72) Inventors: Takumi SAKAMOTO, Toyota-shi (JP); Shiro ODA, Anjo-shi (JP); Takeshi MATSUI, Nisshin-shi (JP)

(73) Assignee: TOYOTA JIDOSHA KABUSHIKI KAISHA, Toyota-shi (JP)

(21) Appl. No.: 18/627,604

(22) Filed: Apr. 5, 2024

(30) Foreign Application Priority Data
Apr. 19, 2023 (JP) 2023-068277

(51) Int. Cl. B25J 5/00; B25J 9/16; B25J 19/00

(52) U.S. Cl. CPC B25J 5/007; B25J 9/161; B25J 9/162; B25J 9/1661; B25J 19/0037

(57) ABSTRACT

A control system includes one or more processors configured to perform system control for controlling a system including a mobile robot configured to move autonomously and transport a transport object. The mobile robot includes a contact portion which comes into contact with a transport box configured to store the transport object when loading and transporting the transport box, and a first light-emitting unit provided around the contact portion and configured to emit light in a predetermined light emission pattern associated with a state of the mobile robot. The transport box includes a box-side light-emitting unit which is a light-emitting unit provided on the transport box. The system control includes control on the box-side light-emitting unit to emit light in a light emission pattern corresponding to the predetermined light emission pattern of the first light-emitting unit when the transport box is loaded on the contact portion.

### CROSS-REFERENCE TO RELATED APPLICATION

This application claims priority to Japanese Patent Application No. 2023-068277 filed on Apr. 19, 2023, incorporated herein by reference in its entirety.

### BACKGROUND

### 1. Technical Field

The present disclosure relates to a control system and a control method.

### 2. Description of Related Art

Japanese Patent No. 7103689 (JP 7103689 B) discloses a mobile robot that can transport an object.

SUMMARY

In the mobile robot described in JP 7103689 B, when a transport box is used to transport an object and an attempt is made to display the state of the mobile robot using a light source, the state of the mobile robot is less visible to the surroundings due to the presence of the transport box.

Therefore, there is a demand to develop such a technology that, when the autonomously movable mobile robot transports an object using the transport box, the state of the mobile robot is displayed for the surroundings in an easily visible way using a light-emitting unit provided around a contact portion that comes into contact with the transport box when the transport box is loaded and transported. That is, there is a demand for a technology to prevent the state of the autonomously movable mobile robot from being less visible to the surroundings due to the presence of the transport box even when the display is performed using the light-emitting unit while the mobile robot transports the transport box.

The present disclosure provides a control system and a control method in which, when an autonomously movable mobile robot transports an object using a transport box and the state of the mobile robot is displayed using a light-emitting unit provided around a contact portion that comes into contact with the transport box when the transport box is loaded and transported, the state of the mobile robot can be prevented from being less visible to the surroundings due to the presence of the transport box.

A control system according to a first aspect of the present disclosure includes one or more processors configured to perform system control for controlling a system including a mobile robot configured to move autonomously and transport a transport object. The mobile robot includes a contact portion which comes into contact with a transport box configured to store the transport object when loading and transporting the transport box, and a first light-emitting unit provided around the contact portion and configured to emit light in a predetermined light emission pattern associated with a state of the mobile robot. The transport box includes a box-side light-emitting unit which is a light -emitting unit provided on the transport box. The system control includes control on the box-side light-emitting unit to emit light in a light emission pattern corresponding to the predetermined light emission pattern of the first light-emitting unit when the transport box is loaded on the contact portion. With such a configuration in the control system, when the autonomously movable mobile robot transports the object using the transport box and the state of the mobile robot is displayed using the light-emitting unit provided around the contact portion that comes into contact with the transport box when the transport box is loaded and transported, the state of the mobile robot can be prevented from being less visible to the surroundings due to the presence of the transport box. In autonomous movement control, the mobile robot may be controlled to move autonomously using a learning model obtained through machine learning.

In the control system according to the first aspect of the present disclosure, the system control may include pattern change control for changing the predetermined light emission pattern of the first light-emitting unit when the transport box is loaded on the contact portion. With such a configuration in the control system, the mobile robot can more clearly notify the surroundings about the state of the mobile robot even when the mobile robot is transporting the transport box.

In the control system according to the first aspect of the present disclosure, in the pattern change control, the predetermined light emission pattern of the first light-emitting unit may be changed when the transport box is loaded on the contact portion to reduce a power consumption of the first light-emitting unit compared to a case where the transport box is not loaded on the contact portion. With such a configuration in the control system, the mobile robot can clearly notify the surroundings about the state of the mobile robot while suppressing unnecessary power consumption even when the mobile robot is transporting the transport box.

In the control system according to the first aspect of the present disclosure, in the pattern change control, the predetermined light emission pattern of the first light-emitting unit may be changed when the transport box is loaded on the contact portion to achieve a state in which a difference falls within a predetermined range, the difference being a difference between a sum of a power consumption of the first light-emitting unit and a power consumption of the box-side light-emitting unit and a power consumption of the first light-emitting unit when the transport box is not loaded on the contact portion. With such a configuration in the control system, the mobile robot can more clearly notify the surroundings about the state of the mobile robot while efficiently using electric power even when the mobile robot is transporting the transport box.

In the control system according to the first aspect of the present disclosure, in the pattern change control, light emission of the first light-emitting unit may be stopped when the transport box is loaded on the contact portion. With such a configuration in the control system, the light emission of the first light-emitting unit may be stopped, the first light-emitting unit being less recognizable from the surroundings when the transport box is loaded compared to the case where the transport box is not loaded. Electric power can thus be used more efficiently.

In the control system according to the first aspect of the present disclosure, the box-side light-emitting unit may be provided on at least one of a lateral surface side or an upper surface side of the transport box. With such a configuration in the control system, the box-side light-emitting unit can be easily recognized from the surroundings.

In the control system according to the first aspect of the present disclosure, the system control may include pattern change control for changing the predetermined light emission pattern of the first light-emitting unit or both the predetermined light emission pattern and the light emission pattern of the box-side light-emitting unit when the mobile robot is traveling near a wall to reduce a power consumption of a light-emitting portion of the first light-emitting unit on a wall side or both the power consumption of the light-emitting portion of the first light-emitting unit on the wall side and a power consumption of a light-emitting portion of the box-side light-emitting unit on the wall side compared to a case where the mobile robot is not traveling near the wall. With such a configuration in the control system, the mobile robot can clearly notify the surroundings about the state of the mobile robot while efficiently using electric power even when the mobile robot is transporting the transport box.

In the control system according to the first aspect of the present disclosure, the state of the mobile robot may include a transporting state indicating whether the mobile robot is transporting the transport object. With such a configuration in the control system, the mobile robot can clearly notify the surroundings of the mobile robot about whether the mobile robot is transporting the transport object.

In the control system according to the first aspect of the present disclosure, the transporting state may include, when the mobile robot is transporting the transport object, information indicating the transport object in the transport box being transported by the mobile robot. With such a configuration in the control system, the mobile robot can clearly notify the surroundings of the mobile robot about the transport object being transported by the mobile robot.

In the control system according to the first aspect of the present disclosure, the transporting state may include, when the mobile robot is transporting the transport object, information indicating a type of the transport box loaded on the contact portion. With such a configuration in the control system, the mobile robot can clearly notify the surroundings of the mobile robot about the type of the transport box being transported by the mobile robot.

In the control system according to the first aspect of the present disclosure, the transport box may be configured to receive electric power supplied from the mobile robot when the transport box is loaded on the contact portion. With such a configuration in the control system, it is possible to eliminate the need to equip the transport box with a power source.

A control method according to a second aspect of the present disclosure includes performing system control for controlling a system including a mobile robot configured to move autonomously and transport a transport object. The mobile robot includes a contact portion which comes into contact with a transport box configured to store the transport object when loading and transporting the transport box, and a first light-emitting unit provided around the contact portion and configured to emit light in a predetermined light emission pattern associated with a state of the mobile robot. The transport box includes a box-side light-emitting unit which is a light-emitting unit provided on the transport box. The system control includes control on the box-side light-emitting unit to emit light in a light emission pattern corresponding to the predetermined light emission pattern of the first light-emitting unit when the transport box is loaded on the contact portion. With such a configuration in the control method, when the autonomously movable mobile robot transports the object using the transport box and the state of the mobile robot is displayed using the light-emitting unit provided around the contact portion that comes into contact with the transport box when the transport box is loaded and transported, the state of the mobile robot can be prevented from being less visible to the surroundings due to the presence of the transport box.

In the control method according to the second aspect of the present disclosure, the system control may include pattern change control for changing the predetermined light emission pattern of the first light-emitting unit when the transport box is loaded on the contact portion. With such a configuration in the control method, the mobile robot can more clearly notify the surroundings about the state of the mobile robot even when the mobile robot is transporting the transport box.

In the control method according to the second aspect of the present disclosure, in the pattern change control, the predetermined light emission pattern of the first light-emitting unit may be changed when the transport box is loaded on the contact portion to reduce a power consumption of the first light-emitting unit compared to a case where the transport box is not loaded on the contact portion. With such a configuration in the control method, the mobile robot can clearly notify the surroundings about the state of the mobile robot while suppressing unnecessary power consumption even when the mobile robot is transporting the transport box.

In the control method according to the second aspect of the present disclosure, in the pattern change control, the predetermined light emission pattern of the first light-emitting unit may be changed when the transport box is loaded on the contact portion to achieve a state in which a difference falls within a predetermined range, the difference being a difference between a sum of a power consumption of the first light-emitting unit and a power consumption of the box-side light-emitting unit and a power consumption of the first light-emitting unit when the transport box is not loaded on the contact portion. With such a configuration in the control method, the mobile robot can more clearly notify the surroundings about the state of the mobile robot while efficiently using electric power even when the mobile robot is transporting the transport box.

In the control method according to the second aspect of the present disclosure, in the pattern change control, light emission of the first light-emitting unit may be stopped when the transport box is loaded on the contact portion. With such a configuration in the control method, the light emission of the first light-emitting unit may be stopped, the first light-emitting unit being less recognizable from the surroundings when the transport box is loaded compared to the case where the transport box is not loaded. Electric power can thus be used more efficiently.

In the control method according to the second aspect of the present disclosure, the box-side light-emitting unit may be provided on at least one of a lateral surface side or an upper surface side of the transport box. With such a configuration in the control method, the box-side light-emitting unit can be easily recognized from the surroundings.

In the control method according to the second aspect of the present disclosure, the system control may include pattern change control for changing the predetermined light emission pattern of the first light-emitting unit or both the predetermined light emission pattern and the light emission pattern of the box-side light-emitting unit when the mobile robot is traveling near a wall to reduce a power consumption of a light-emitting portion of the first light-emitting unit on a wall side or both the power consumption of the light-emitting portion of the first light-emitting unit on the wall side and a power consumption of a light-emitting portion of the box-side light-emitting unit on the wall side compared to a case where the mobile robot is not traveling near the wall. With such a configuration in the control method, the mobile robot can clearly notify the surroundings about the state of the mobile robot while efficiently using electric power even when the mobile robot is transporting the transport box.

In the control method according to the second aspect of the present disclosure, the state of the mobile robot may include a transporting state indicating whether the mobile robot is transporting the transport object. With such a configuration in the control method, the mobile robot can clearly notify the surroundings of the mobile robot about whether the mobile robot is transporting the transport object.

In the control method according to the second aspect of the present disclosure, the transporting state may include, when the mobile robot is transporting the transport object, information indicating the transport object in the transport box being transported by the mobile robot. With such a configuration in the control method, the mobile robot can clearly notify the surroundings of the mobile robot about the transport object being transported by the mobile robot.

According to the present disclosure, it is possible to provide the control system and the control method in which, when the autonomously movable mobile robot transports the object using the transport box and the state of the mobile robot is displayed using the light-emitting unit provided around the contact portion that comes into contact with the transport box when the transport box is loaded and transported, the state of the mobile robot can be prevented from being less visible to the surroundings due to the presence of the transport box.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view showing an example of the overall configuration of a mobile robot according to an embodiment;

FIG. 2 is a perspective view showing an example of the overall configuration of a wagon to be transported by the mobile robot in FIG. 1;

FIG. 3 is a perspective view showing how the mobile robot in FIG. 1 transports the wagon in FIG. 2;

FIG. 4 is a flowchart illustrating an example of a light emission process that is performed by the mobile robot in FIG. 1;

FIG. 5 shows an example of light emission patterns that can be implemented by the mobile robot in FIG. 1;

FIG. 6 is a flowchart illustrating another example of the light emission process that is performed by the mobile robot in FIG. 1;

FIG. 7 shows another example of the light emission patterns that can be implemented by the mobile robot in FIG. 1;

FIG. 8 is a perspective view showing how the mobile robot in FIG. 1 transports a wagon in another configuration example;

FIG. 9 is a flowchart illustrating still another example of the light emission process that is performed by the mobile robot in FIG. 1;

FIG. 10 is a schematic diagram showing a specific example of the light emission process in FIG. 9;

FIG. 11 is a schematic diagram showing an example of the overall configuration of a system including the mobile robot according to the embodiment;

FIG. 12 is a flowchart illustrating an example of a process that is performed by a host management device in the system in FIG. 11; and

FIG. 13 shows an example of the hardware configuration of a device.

### DETAILED DESCRIPTION OF EMBODIMENTS

In the control method according to the second aspect of the present disclosure, the transporting state may include, when the mobile robot is transporting the transport object, information indicating a type of the transport box loaded on the contact portion. With such a configuration in the control method, the mobile robot can clearly notify the surroundings of the mobile robot about the type of the transport box being transported by the mobile robot.

In the control method according to the second aspect of the present disclosure, the transport box may be configured to receive electric power supplied from the mobile robot when the transport box is loaded on the contact portion. With such a configuration in the control method, it is possible to eliminate the need to equip the transport box with a power source.

A non-transitory storage medium according to a third aspect of the present disclosure may store instructions that are executable by one or more processors and that cause the one or more processors to perform functions. The functions may include performing system control for controlling a system including a mobile robot configured to move autonomously and transport a transport object. The mobile robot may include a contact portion which comes into contact with a transport box configured to store the transport object when loading and transporting the transport box, and a first light-emitting unit provided around the contact portion and configured to emit light in a predetermined light emission pattern associated with a state of the mobile robot. The transport box may include a box-side light-emitting unit which is a light-emitting unit provided on the transport box. The system control may include control on the box-side light-emitting unit to emit light in a light emission pattern corresponding to the predetermined light emission pattern of the first light-emitting unit when the transport box is loaded on the contact portion. With such a configuration in the non-transitory storage medium, when the autonomously movable mobile robot transports the object using the transport box and the state of the mobile robot is displayed using the light-emitting unit provided around the contact portion that comes into contact with the transport box when the transport box is loaded and transported, the state of the mobile robot can be prevented from being less visible to the surroundings due to the presence of the transport box.

In the non-transitory storage medium according to the third aspect of the present disclosure, the system control may include pattern change control for changing the predetermined light emission pattern of the first light-emitting unit when the transport box is loaded on the contact portion. With such a configuration in the non-transitory storage medium, the mobile robot can more clearly notify the surroundings about the state of the mobile robot even when the mobile robot is transporting the transport box.

In the non-transitory storage medium according to the third aspect of the present disclosure, in the pattern change control, the predetermined light emission pattern of the first light-emitting unit may be changed when the transport box is loaded on the contact portion to reduce a power consumption of the first light-emitting unit compared to a case where the transport box is not loaded on the contact portion. With such a configuration in the non-transitory storage medium, the mobile robot can clearly notify the surroundings about the state of the mobile robot while suppressing unnecessary power consumption even when the mobile robot is transporting the transport box.

In the non-transitory storage medium according to the third aspect of the present disclosure, in the pattern change control, the predetermined light emission pattern of the first light-emitting unit may be changed when the transport box is loaded on the contact portion to achieve a state in which a difference falls within a predetermined range, the difference being a difference between a sum of a power consumption of the first light-emitting unit and a power consumption of the box-side light-emitting unit and a power consumption of the first light-emitting unit when the transport box is not loaded on the contact portion. With such a configuration in the non-transitory storage medium, the mobile robot can more clearly notify the surroundings about the state of the mobile robot while efficiently using electric power even when the mobile robot is transporting the transport box.

In the non-transitory storage medium according to the third aspect of the present disclosure, in the pattern change control, light emission of the first light-emitting unit may be stopped when the transport box is loaded on the contact portion. With such a configuration in the non-transitory storage medium, the light emission of the first light-emitting unit may be stopped, the first light-emitting unit being less recognizable from the surroundings when the transport box is loaded compared to the case where the transport box is not loaded. Electric power can thus be used more efficiently.

In the non-transitory storage medium according to the third aspect of the present disclosure, the box-side light-emitting unit may be provided on at least one of a lateral surface side or an upper surface side of the transport box. With such a configuration in the non-transitory storage medium, the box-side light-emitting unit can be easily recognized from the surroundings.

In the non-transitory storage medium according to the third aspect of the present disclosure, the system control may include pattern change control for changing the predetermined light emission pattern of the first light-emitting unit or both the predetermined light emission pattern and the light emission pattern of the box-side light-emitting unit when the mobile robot is traveling near a wall to reduce a power consumption of a light-emitting portion of the first light-emitting unit on a wall side or both the power consumption of the light-emitting portion of the first light-emitting unit on the wall side and a power consumption of a light-emitting portion of the box-side light-emitting unit on the wall side compared to a case where the mobile robot is not traveling near the wall. With such a configuration in the non-transitory storage medium, the mobile robot can clearly notify the surroundings about the state of the mobile robot while efficiently using electric power even when the mobile robot is transporting the transport box.

In the non-transitory storage medium according to the third aspect of the present disclosure, the state of the mobile robot may include a transporting state indicating whether the mobile robot is transporting the transport object. With such a configuration in the non-transitory storage medium, the mobile robot can clearly notify the surroundings of the mobile robot about whether the mobile robot is transporting the transport object.

In the non-transitory storage medium according to the third aspect of the

present disclosure, the transporting state may include, when the mobile robot is transporting the transport object, information indicating the transport object in the transport box being transported by the mobile robot. With such a configuration in the non-transitory storage medium, the mobile robot can clearly notify the surroundings of the mobile robot about the transport object being transported by the mobile robot.

In the non-transitory storage medium according to the third aspect of the present disclosure, the transporting state may include, when the mobile robot is transporting the transport object, information indicating a type of the transport box loaded on the contact portion. With such a configuration in the non-transitory storage medium, the mobile robot can clearly notify the surroundings of the mobile robot about the type of the transport box being transported by the mobile robot.

In the non-transitory storage medium according to the third aspect of the present disclosure, the transport box may be configured to receive electric power supplied from the mobile robot when the transport box is loaded on the contact portion. With such a configuration in the non-transitory storage medium, it is possible to eliminate the need to equip the transport box with a power source.

Hereinafter, the present disclosure will be described based on an embodiment. However, the present disclosure according to the claims is not limited to the following embodiment. All the configurations described in the embodiment are not necessarily essential as means for solving the problem.

### Embodiment

A control system according to the present embodiment performs system control for controlling a system including an autonomously movable mobile robot that can transport an object (hereinafter this system will be referred to as “transport system”). This mobile robot can also be referred to as “transport robot” because it can transport an object.

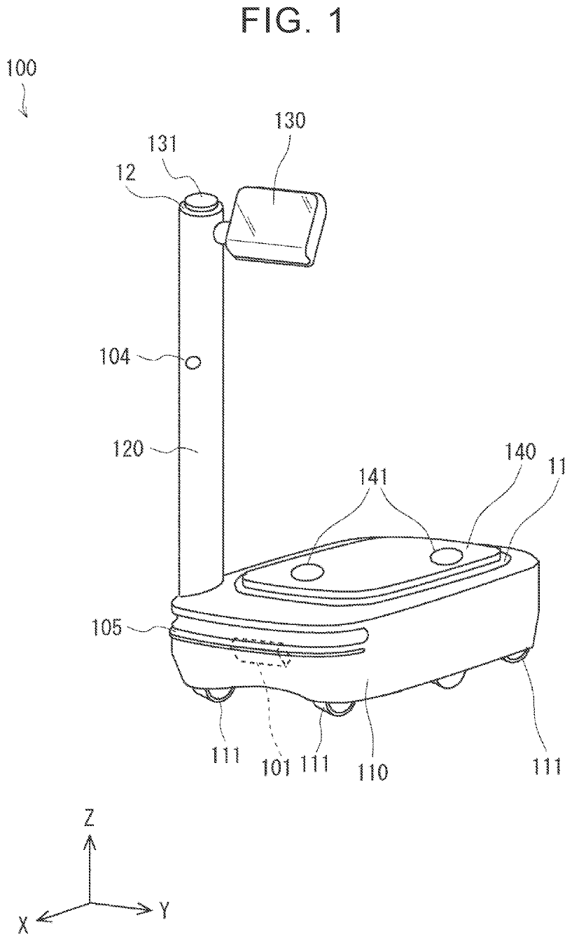

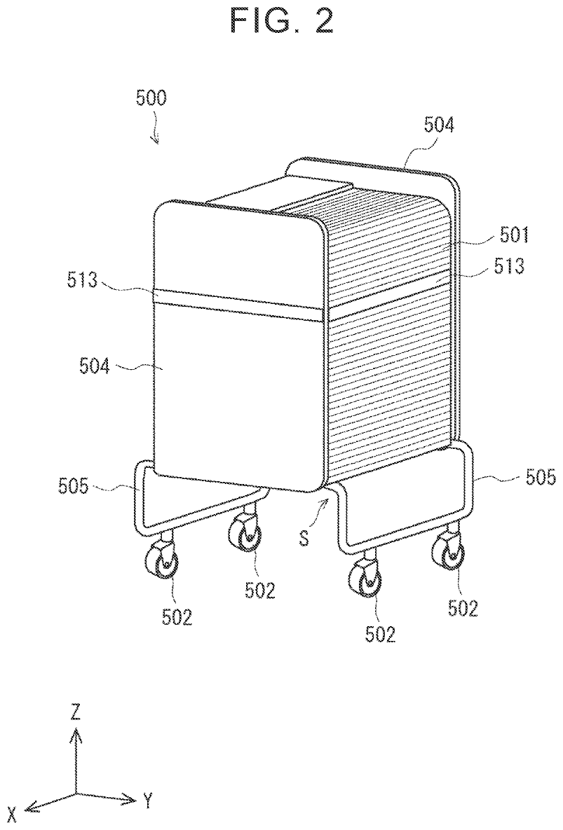

An example of the configuration of the mobile robot according to the present embodiment will be described below with reference to FIGS. 1 and 2. FIG. 1 is a perspective view showing an example of the overall configuration of the mobile robot according to the present embodiment, and FIG. 2 is a perspective view showing an example of the overall configuration of a wagon to be transported by the mobile robot in FIG. 1.

The transport system only needs to include a mobile robot such as a mobile robot 100 shown in FIG. 1 and a transport box such as a wagon 500 shown in FIG. 2. The transport system may further include other devices such as a host management device. For simplicity of description, an example will first be given in which the transport system is composed of the mobile robot 100 and the wagon 500. Main features of the transport system will be described. In this example, the term “control system” can refer to either the mobile robot 100 and the wagon 500 or components of control systems in the mobile robot 100 and the wagon 500.

In the following description, an XYZ orthogonal coordinate system will be used as appropriate. An X direction is a front-rear direction of the mobile robot 100 in FIG. 1, a Y direction is a right-left direction of the mobile robot 100 in FIG. 1, and a Z direction is a vertical up-down direction. More specifically, a +X direction is defined as a forward direction of the mobile robot 100, and a −X direction is defined as a rearward direction of the mobile robot 100. A +Y direction is a leftward direction of the mobile robot 100, and a −Y direction is a rightward direction of the mobile robot 100. A +Z direction is a vertically upward direction, and a −Z direction is a vertically downward direction.

The mobile robot 100 is movable in both the forward and rearward directions. That is, the mobile robot 100 moves in the forward direction when its wheels are rotated forward, and moves in the rearward direction when the wheels are rotated in reverse. Changing the rotational speed between the right and left wheels allows the mobile robot 100 to turn right or left.

As shown in FIG. 1, the mobile robot 100 can include a platform 110 on which an object to be transported (hereinafter also referred to as “transport object”) is to be loaded, a stand 120, and an operation unit 130. The platform 110 is equipped with wheels 111, axles, a battery, a control computer 101, a drive motor, etc. It is assumed that the control computer 101 is mounted at the illustrated position in the platform 110. However, the control computer 101 need not necessarily be mounted at this position. The control computer 101 may be mounted at any other position in the platform 110, or part of the control computer 101 or the entire control computer 101 may be mounted in either or both of the stand 120 and the operation unit 130.

The platform 110 rotatably holds the wheels 111. In the example of FIG. 1, the platform 110 is provided with four wheels 111. The four wheels 111 are right and left front wheels, and right and left rear wheels. The mobile robot 100 moves along a desired route by independently controlling the rotational directions and the rotational speeds of the wheels 111. Part of the four wheels 111 may be drive wheels, and the rest of the wheels 111 may be driven wheels. As shown in FIG. 1, an additional driven wheel(s) may be provided between the front and rear wheels 111.

In order to, for example, prevent contact with obstacles and check the route, various sensors such as a camera and a distance sensor may be provided on at least one of the following components: the platform 110, the operation unit 130, and the stand 120.

FIG. 1 illustrates an example in which a camera 104 and a sensor 105 are provided as such sensors. The camera 104 faces the +X side on the stand 120, and the sensor 105 is provided on the front side of the platform 110. A bumper may be installed on the front side of the platform 110, and the sensor 105 may be mounted on the bumper. The sensor 105 detects that any object comes into contact with the bumper. The mobile robot 100 can be controlled to stop when the sensor 105 detects contact of any object, that is, any obstacle. Therefore, the sensor 105 can be referred to as “stop sensor”. The sensor 105 need not necessarily be mounted on the front side. The sensor 105 may be a sensor that detects contact of an object with a bumper installed on part or all of the outer periphery of the mobile robot 100.

The mobile robot 100 is an autonomous mobile robot. However, the mobile robot 100 may have a function to move according to user's operations. That is, the mobile robot 100 may be a mobile robot configured to switch between an autonomous movement mode and a user operation mode. By the autonomous movement control, the mobile robot 100 can be controlled to move autonomously based on a route determined according to a set transport destination or a set route. In the autonomous movement control, the mobile robot 100 can also be controlled to move autonomously by determining a route, performing contact avoidance, etc. using a learning model obtained through machine learning.

The user operation mode in which the mobile robot 100 moves based on user operations may be any mode as long as the degree of involvement of the user operations is relatively high compared to the autonomous movement mode in which the mobile robot 100 moves autonomously. In other words, the user operation mode need not be limited to a mode in which the user controls all movements of the mobile robot with no autonomous control by the mobile robot. Similarly, the autonomous movement mode need not be limited to a mode in which the mobile robot performs fully autonomous control and does not accept any user operations. For example, the user operation mode and the autonomous movement mode may include the following first to third examples.

In the first example, the autonomous movement mode is a mode in which the mobile robot travels autonomously and determines when to stop and when to start traveling and the user does not perform any operations, and the user operation mode is a mode in which the mobile robot travels autonomously and the user operates to stop the mobile robot and to control the mobile robot to start traveling. In the second example, the autonomous movement mode is a mode in which the mobile robot travels autonomously and the user operates to stop the mobile robot and to control the mobile robot to start traveling, and the user operation mode is a mode in which the mobile robot does not travel autonomously and the user not only operates to stop the mobile robot and to control the mobile robot to start traveling but also operates to control the mobile robot to travel. In the third example, the autonomous movement mode is a mode in which the mobile robot travels autonomously and determines when to stop and when to start traveling and the user does not perform any operations, and the user operation mode is a mode in which the mobile robot travels autonomously for speed adjustment, contact avoidance, etc. and the user operates to change the direction of travel and the route etc.

The user may be a worker etc. at a facility where the mobile robot 100 is utilized, and may be a hospital worker when the facility is a hospital.

The control computer 101 can be implemented by, for example, integrated circuitry, and can be implemented by, for example, a processor such as a micro processor unit (MPU) or a central processing unit (CPU), a working memory, and a nonvolatile storage device. Control programs to be executed by the processor are stored in the storage device, and the processor can perform the function to control the mobile robot 100 by loading the programs into the working memory and executing them. The control computer 101 can be referred to as “control unit”.

The control computer 101 controls the mobile robot 100 to move autonomously toward a preset transport destination or along a preset transport route, based on prestored map data and information acquired by the various sensors exemplified by the camera 104. This autonomous movement control can include control for loading the wagon 500 shown in FIG. 2 and control for unloading the wagon 500. The wagon 500 is an example of the transport box. The wagon 500 will be described later. It can be said that the control computer 101 can include a movement control unit that performs such autonomous movement control.

In order to load and unload a transport object such as the wagon 500, the platform 110 can include a lifting mechanism 140 for loading and unloading a transport object. Part of the lifting mechanism 140 can be housed inside the platform 110. The lifting mechanism 140 can be installed with its loading surface, namely its surface on which a transport object is to be loaded, being exposed on the upper surface side of the platform 110. The lifting mechanism 140 is a lifting stage configured to be raised and lowered, and can be raised and lowered as controlled by the control computer 101. The platform 110 is provided with a motor and a guide mechanism for the raising and lowering of the lifting mechanism 140. An upper surface of the lifting mechanism 140 serves as the loading surface on which the wagon 500 as a transport object is to be loaded. The wagon 500 is not limited to the configuration shown in FIG. 2, and may be any predetermined wagon of a size, shape, and weight that is loadable and transportable on the lifting mechanism 140. The lifting mechanism 140 includes a lift mechanism for lifting the wagon 500. Space above the lifting mechanism 140 serves as a loading space for loading a transport object. As far as the user loads the wagon 500, the platform 110 need not include the lifting mechanism 140.

The platform 110 can include a first light-emitting unit 11 at a position around the lifting mechanism 140. The first light-emitting unit 11 may have any configuration as long as it can emit light. The first light-emitting unit 11 can be composed of, for example, one or more light-emitting diodes (LEDs) or organic electroluminescence, and its light emission can be controlled by the control computer 101. The position, shape, and size of the first light-emitting unit 11 are not limited to those illustrated in the drawings. The mobile robot 100 can include the first light-emitting unit 11 even when the mobile robot 100 does not include the lifting mechanism 140.

The stand 120 is attached to the platform 110. The stand 120 is a rod-shaped member extending upward from the platform 110. In this example, the stand 120 is in a columnar shape that is long in the Z direction. However, the stand 120 may be in any shape, and the mobile robot 100 need not include the stand 120. The longitudinal direction of the stand 120 is parallel to the Z direction. The stand 120 is installed outside the lifting mechanism 140. That is, the stand 120 is installed so as not to interfere with the rising and lowering movements of the lifting mechanism 140. The stand 120 is installed on one end side of the platform 110 in the Y direction (right-left direction). The stand 120 is attached near the right front corner of the platform 110. The stand 120 is installed at the end of the platform 110 that is located on the +X side and −Y side on an XY plane.

The stand 120 may be provided with, for example, a stick portion 131 of a joystick device or an emergency stop button for stopping the mobile robot 100 in case of emergency, on its upper surface portion. The joystick device is a device that is operated to move the mobile robot 100 in a direction intended by the user in the user operation mode. The joystick device can receive a directional operation when the stick portion 131 is tilted in a direction in which the user wants the mobile robot 100 to move. The joystick device can also be controlled to perform a select operation by depressing the stick portion 131. The stick portion 131 may serve as an emergency stop button when it is depressed for a predetermined period. In the case where the stick portion 131 is configured to also receive a select operation, this predetermined period only needs to be set to a different value from a period for the select operation.

The stand 120 can include a second light-emitting unit 12 at a position around the stick portion 131. The second light-emitting unit 12 may have any configuration as long as it can emit light. The second light-emitting unit 12 may be composed of, for example, one or more LEDs or organic electroluminescence, and its light emission can be controlled by the control computer 101. The position, shape, and size of the second light-emitting unit 12 are not limited to those illustrated in the drawings.

The stand 120 supports the operation unit 130. The operation unit 130 is attached near the upper end of the stand 120. Thus, the operation unit 130 can be installed at a height at which the operation unit 130 is easily operable by the user. That is, the stand 120 extends to a height at which the standing user can perform operations easily, and the stick portion 131 is also disposed at a height at which the stick portion 131 is easily operable by the user. The operation unit 130 extends to the +Y side from the stand 120. From the standpoint of case of operation, the operation unit 130 can be mounted in the middle in the right-left direction of the platform 110.

The operation unit 130 can include a touch panel monitor etc. that receives user operations. The operation unit 130 may include a microphone etc. for audio input. The monitor of the operation unit 130 faces the opposite side from the platform 110. That is, a display surface (operation surface) of the operation unit 130 is a surface on the +X side. The operation unit 130 may be provided to be detachable from the stand 120. That is, a holder that holds the touch panel may be attached to the stand 120. The user can enter a transport destination of a transport object, transport information about the transport object, etc. by operating the operation unit 130. The operation unit 130 can display, to the user, information such as details of an object being transported or an object to be transported and a destination of the object. The mobile robot 100 need not include the operation unit 130.

As illustrated in the drawings, the operation unit 130 and the stick portion 131 can be mounted at least at about the same height so that they can be operated intuitively. Thus, the user can intuitively operate the operation unit 130 and the stick portion 131 even when an operation to depress the stick portion 131 is assigned to an operation to select details of an operation displayed on the operation unit 130.

An integrated circuit (IC) card reader for the user to get authenticated using an IC card etc. may be installed on the stand 120 at about the same height position as that of the operation unit 130 or inside the operation unit 130. Although the mobile robot 100 need not necessarily have a user authentication function, the mobile robot 100 with the user authentication function can block mischievous operations by a third party etc. The user authentication function is not limited to the type using an IC card, and may be of the type using user information and password that are entered via the operation unit 130. However, the user authentication function of the type using various short-range wireless communication technologies that allow contactless authentication can save the user a hassle and can prevent infection.

The user can place a transport object in the wagon 500 loaded on the mobile robot 100 and request the mobile robot 100 to transport the object. The wagon 500 itself can also be referred to as “transport object”. Therefore, for convenience, a transport object that is placed in the wagon 500 will be hereinafter referred to as “article” in order to distinguish between them. The mobile robot 100 transports the wagon 500 by autonomously moving to a set destination. That is, the mobile robot 100 performs the task of transporting the wagon 500. In the following description, a location where the wagon 500 is loaded will be referred to as “transport origin” or “loading location”, and a location to which the wagon 500 is delivered will be referred to as “transport destination” or “destination”.

For example, it is assumed that the mobile robot 100 moves around a general hospital with a plurality of clinical departments. The mobile robot 100 transports an article such as supplies, consumables, and medical equipment between the clinical departments. For example, the mobile robot 100 delivers an article from a nurses' station of one clinical department to a nurses' station of another clinical department. Alternatively, the mobile robot 100 delivers an article from a storage for supplies and medical equipment to a nurses' station of a clinical department. The mobile robot 100 also delivers medicine dispensed in a dispensing department to a clinical department or patient expected to use the medicine.

Examples of the article include medicines, consumables such as bandages, specimens, test equipment, medical equipment, hospital foods, and supplies such as stationery. Examples of the medical equipment include sphygmomanometers, blood transfusion pumps, syringe pumps, foot pumps, nurse call buttons, bed leaving sensors, low-pressure continuous suction devices, electrocardiogram monitors, infusion controllers, enteral feeding pumps, ventilators, cuff pressure gauges, touch sensors, inhalers, nebulizers, pulse oximeters, artificial resuscitators, aseptic isolators, and ultrasound diagnostic equipment. The mobile robot 100 may transport meals such as hospital foods and foods for a special diet a patient follows to prepare for a test. The mobile robot 100 may transport used equipment, used tableware, etc. When the transport destination is on a different floor, the mobile robot 100 may move using an elevator etc.

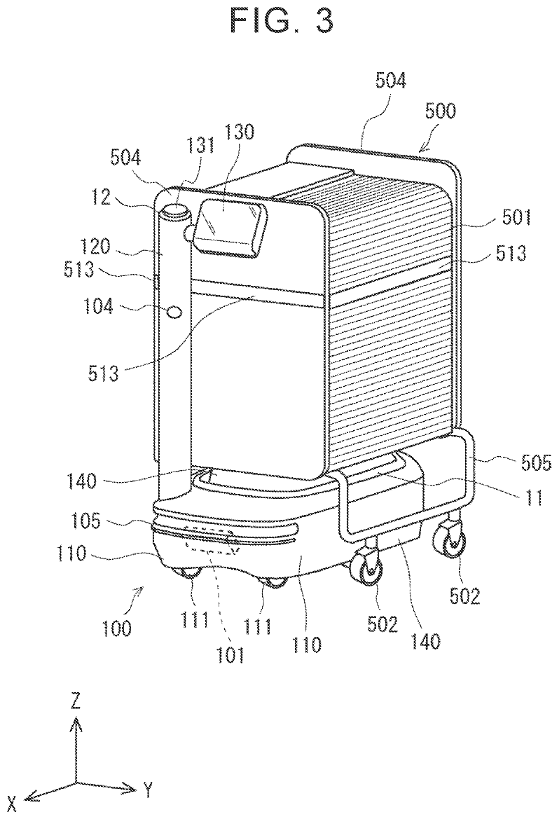

Next, details of the wagon 500 and an example of how the mobile robot 100 holds the wagon 500 will be described with reference to FIGS. 2 and 3. FIG. 3 is a perspective view showing how the mobile robot 100 transports the wagon 500.

The wagon 500 includes a storage portion configured to store an article, and a support portion supporting the storage portion with a space under the storage portion to allow insertion of at least part of the platform 110. As shown in FIG. 2, the storage portion can include side plates 504 on both sides of the wagon 500 and a cover 501 that can be opened and closed. When the user opens the cover 501, an article can be loaded into and unloaded from the wagon 500. As shown in FIG. 2, the support portion can include a support frame 505 supporting the storage portion, and wheels 502 attached to the lower side of the support frame 505. The wheels 502 may be provided with covers (not shown).

The wagon 500 can be held by the lifting mechanism 140 of the mobile robot 100 as described above. The lifting mechanism 140 is a mechanism for loading and unloading the wagon 500 as a transport object onto and from the upper surface side of at least part of the platform 110. Since the mobile robot 100 includes the lifting mechanism 140, the mobile robot 100 can easily automatically transport the wagon 500.

As shown in FIG. 3, the mobile robot 100 can hold the wagon 500 by the lifting mechanism 140. The space to allow insertion of at least part of the platform 110 is a space S under the wagon 500 shown in FIG. 2. This space S is a space into which the platform 110 is to be inserted. That is, the platform 110 can enter the space S directly under the wagon 500. When loading the wagon 500 onto the platform 110, the mobile robot 100 moves in the −X direction and enters directly under the wagon 500. The platform 110 enters directly under the wagon 500 from the side in the front-rear direction on which the stand 120 is not installed. The wagon 500 can thus be loaded without the stand 120 interfering with the wagon 500. In other words, the stand 120 can be attached near the corner of the platform 110 so as not to interfere with the wagon 500.

As shown in FIG. 1, a contact portion of the lifting mechanism 140 can have recesses 141. The contact portion is a portion that comes into contact with the bottom surface of the wagon 500 by, for example, coupling or connection when the wagon 500 loaded on the lifting mechanism 140 is transported. This contact portion can be the upper surface of the lifting mechanism 140. The wagon 500 can have protrusions (not shown) on the lower side of the storage portion. The wagon 500 can be fixed to the mobile robot 100 by fitting the protrusions into the recesses 141. The wagon 500 can include a box-side light-emitting unit that is a light-emitting unit mounted on the transport box. In the case where the transport box is the wagon 500, the box-side light-emitting unit is a light-emitting unit mounted on the wagon 500. Therefore, it will be described as “wagon-side light-emitting unit 513”. The wagon-side light-emitting unit 513 and the fitting will be described later.

Although the wagon 500 is illustrated as a cart with the wheels 502, the form and configuration of the wagon 500 are not particularly limited. The predetermined wagon exemplified by the wagon 500 may be any wagon as long as it has a shape, size, and weight at which it is transportable by the mobile robot 100.

The operations of loading the wagon 500, transporting the wagon 500 to a transport destination, and unloading the wagon 500 by the mobile robot 100 will be described. First, regarding the loading of the wagon 500, the mobile robot 100 can be a mobile robot that is set in advance to transport the wagon 500 and moves in search of the wagon 500 or moves to a known position. For example, the wagon 500 whose position is specified by the user can be assigned to the mobile robot 100 as an object to be transported or an object to be searched for, and the mobile robot 100 can autonomously move in order to transport the wagon 500. Alternatively, the mobile robot 100 may automatically transport the wagon 500 to a transport destination when it finds the wagon 500 on the way back after finishing a task of transporting another wagon or an article. The present disclosure is not limited to these examples, and various methods can be applied to the utilization of the mobile robot 100 for transport of the wagon 500.

The mobile robot 100 moves to the position of the wagon 500, and the control computer 101 recognizes the wagon 500 based on information acquired by the camera 104 or any other sensor, and controls the lifting mechanism 140 to load the wagon 500. This control to load the wagon 500 can also be referred to as “pickup control”.

In the pickup control, the platform 110 is first inserted into the space S directly under the wagon 500, and the lifting mechanism 140 is raised when the insertion is completed. The lifting stage that is the upper surface of the lifting mechanism 140 thus comes into contact with the wagon 500, so that the lifting mechanism 140 can lift the wagon 500. That is, as the lifting mechanism 140 rises, the wheels 502 are lifted off the floor surface, and the wagon 500 is loaded onto the platform 110. The mobile robot 100 is thus docked with the wagon 500 and becomes ready to head to the transport destination. The control computer 101 then controls driving of the wheels 111 etc. so that the mobile robot 100 moves autonomously along a set route. The mobile robot 100 thus transports the wagon 500 to the transport destination.

The mobile robot 100 moves to the transport destination of the wagon 500, and the control computer 101 controls the lifting mechanism 140 to unload the wagon 500. In this control, the lifting mechanism 140 is lowered to unload the wagon 500 from the platform 110. The wheels 502 come into contact with the floor surface, and the upper surface of the lifting mechanism 140 is separated from the wagon 500. The wagon 500 is thus placed on the floor surface. The wagon 500 can be unloaded from the platform 110 in this manner.

The above various examples are given on the assumption that the mobile robot 100 transports a wagon such as the wagon 500 as a transport object. Even in the case where the mobile robot 100 is configured to transport a wagon, however, the mobile robot 100 may be utilized to transport an individual article (load) as a transport object. In that case, a storage box or shelf that keeps the article from falling while the mobile robot 100 is moving may be attached to the mobile robot 100.

There may be situations where the mobile robot 100 is utilized to transport a plurality of articles and it is necessary to transport the articles to a plurality of transport destinations. In this case, the user can unload the articles at the transport destinations regardless of whether the wagon 500 is used for transport. The mobile robot 100 can transport a wagon or an individual article(s) by autonomously moving to a set destination or by moving to a set destination according to user operations.

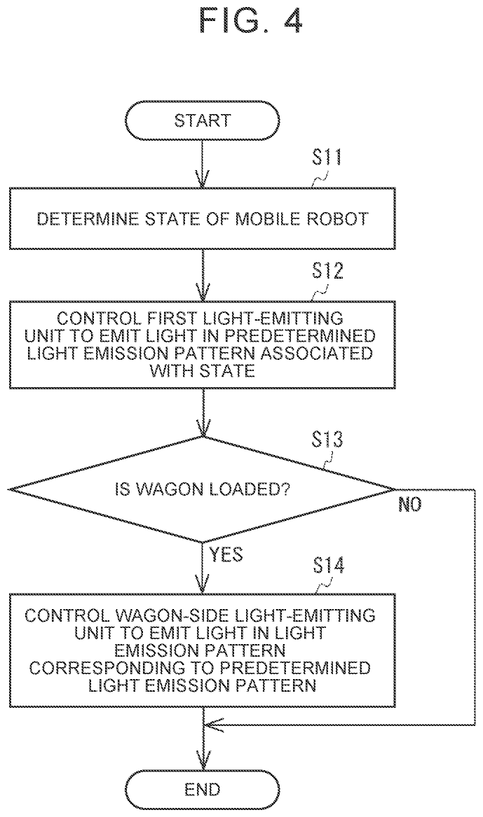

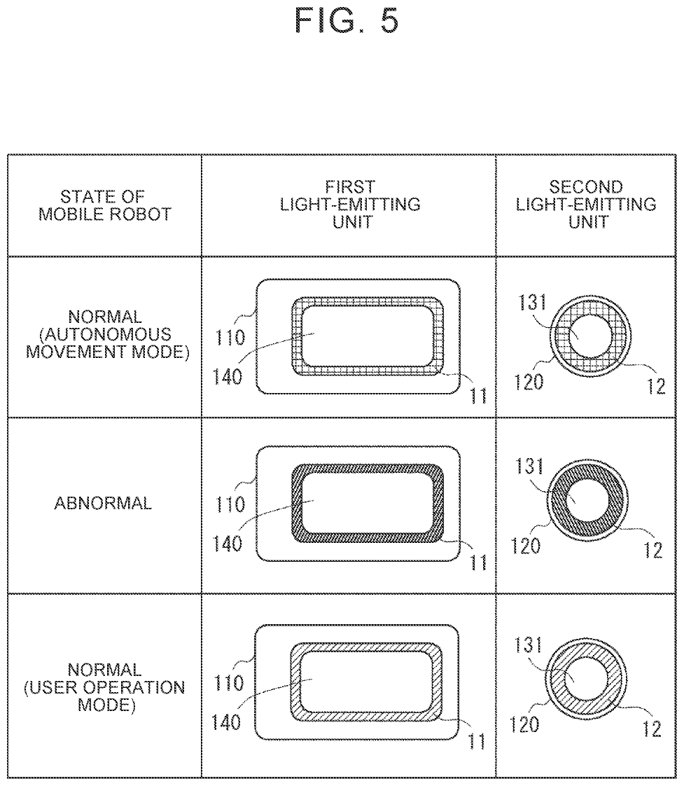

Next, an example of a main feature of the present embodiment will be described with reference to FIGS. 4 and 5. FIG. 4 is a flowchart illustrating an example of a light emission process that is performed by the mobile robot 100. FIG. 5 shows an example of light emission patterns that can be implemented by the mobile robot 100.

As the main feature of the present embodiment, the mobile robot 100 includes the first light-emitting unit 11. As described above, the first light-emitting unit 11 is a light-emitting unit mounted around the contact portion that may come into contact with the wagon 500 storing an article when the wagon 500 is loaded and transported. This contact portion can also be referred to as “loading surface”. The first light-emitting unit 11 is mounted around the contact portion on the body of the mobile robot 100. This contact portion is a portion that comes into contact with the wagon 500 when the loaded wagon 500 is transported. For example, a portion that comes into contact with the wagon 500 only during loading before transport of the wagon 500 can be excluded from the contact portion. The contact portion can be, for example, a contact portion that comes into contact with the bottom surface of the wagon 500. Therefore, a portion that comes into contact with a lateral surface of the wagon 500 can be excluded from the contact portion. Although possible examples of the wagon 500 include various transport boxes with various sizes and shapes, the contact portion that may come into contact with the transport box such as the wagon 500 can refer to a portion that has a possibility of being in contact with the transport box such as the wagon 500 during transport of the transport box such as the wagon 500, as typified by the upper surface of the lifting mechanism 140. Therefore, when the loaded transport box such as the wagon 500 or any other loaded transport object is being transported, light emitted from the first light-emitting unit 11 is visible, for example, at least from obliquely above the mobile robot 100 or from the side of the mobile robot 100. The first light-emitting unit 11 is a light-emitting unit that emits light in a predetermined light emission pattern associated with the state of the mobile robot 100. The light emission pattern can also be referred to as “light emission mode”. Examples of the state of the mobile robot 100 include various states such as whether the mobile robot 100 is transporting an article, whether an operation error has occurred in the mobile robot 100, and whether the mobile robot 100 is in the autonomous movement mode or the user operation mode.

The mobile robot 100 can include not only the first light-emitting unit 11 but also the second light-emitting unit 12. An example will be given in which the mobile robot 100 includes one light-emitting unit in addition to the first light-emitting unit exemplified by the first light-emitting unit 11. However, the mobile robot 100 may include a plurality of light-emitting units in addition to the first light-emitting unit, or may include a plurality of light-emitting units as the first light-emitting unit. The mounting position, shape, and size of each light-emitting unit are not limited to those illustrated. From the viewpoint of visibility from the surroundings, the light-emitting units other than the first light-emitting unit 11 are preferably mounted at positions away from the first light-emitting unit 11, as exemplified by the second light-emitting unit 12.

It is assumed that the wagon 500 utilized in the present embodiment includes the wagon-side light-emitting unit. The wagon-side light-emitting unit can be provided on, but not limited to, at least one of the lateral surface side and the upper surface side of the wagon 500. By providing the wagon-side light-emitting unit on at least one of the lateral surface side and the upper surface side of the wagon 500, the box-side light-emitting unit can be easily recognized from the surroundings. FIGS. 2 and 3 illustrate an example in which the wagon-side light-emitting unit 513 is provided on the periphery of the wagon 500 as the wagon-side light-emitting unit. As described above, the wagon-side light-emitting unit may be located on the upper surface of the wagon 500. Even when the wagon-side light-emitting unit is provided on the periphery of the wagon 500, the mounting height is not limited to the height shown in the figures. The wagon-side light-emitting unit may be provided on a lateral surface of the wagon 500 instead of the periphery of the wagon 500. For example, the wagon-side light-emitting unit may be provided only on the front, rear, left, or right side of the wagon 500.

As at least part of the system control described above, the control computer 101 controls the wagon-side light-emitting unit 513 to emit light in a light emission pattern corresponding to the predetermined light emission pattern of the first light-emitting unit 11 when the wagon 500 is loaded onto the contact portion. The case where the wagon 500 is loaded onto the contact portion is synonymous with the case where the wagon 500 comes into contact with the contact portion or the case where the wagon 500 is loaded onto and brought into contact with the contact portion. The light emission control on the wagon-side light-emitting unit 513 may be performed at any timing such as a timing to start transport as long as the timing is after the wagon 500 comes into contact with the contact portion and the control is enabled.

The light emission control on the wagon-side light-emitting unit 513 from the control computer 101 can be performed, for example, as follows. The light emission control on the wagon-side light-emitting unit 513 can be performed by fitting the protrusions of the wagon 500 into the recesses 141 and electrically connecting the control computer 101 and the wagon-side light-emitting unit 513. The light emission control itself can also be implemented by providing the mobile robot 100 and the wagon 500 with wireless communication units using a short-range wireless communication technology.

The transport system including the mobile robot 100 and the wagon 500 can be configured to supply electric power from the mobile robot 100 to the wagon 500, that is, to supply electric power to the wagon-side light-emitting unit 513, by the fitting. Electric power can be supplied by electrical contact between the recesses 141 and the protrusions, but may be supplied by contactless power feeding in the fitted state.

In this way, the wagon 500 may receive electric power from the mobile robot 100 when the wagon 500 is loaded onto and brought into contact with the contact portion. This configuration can eliminate the need to equip the wagon 500 with a power source. By omitting the power source from the wagon 500, it is possible to reduce the weight of the transport box that may be moved by workers such as hospital staff. A battery may be mounted on the wagon 500. In that case, the battery can be charged from the mobile robot 100 by the fitting.

In order to control the light emission of the first light-emitting unit 11 and the light emission of the wagon-side light-emitting unit 513, the control computer 101 determines the state of the mobile robot 100 (step S11).

In step S11, the control computer 101 can determine, as the state of the mobile robot 100, a traveling state of the mobile robot 100 based on detection results from sensors such as the sensor 105, or an operating state indicating whether the mobile robot 100 has an operational abnormality. Whether the mobile robot 100 has an operational abnormality can be determined based on detection results from various sensors installed on the mobile robot 100. The determination of the operating state is made as to, for example, whether there is any operational abnormality, and where is the location of the abnormality, such as the battery, the drive unit, or any wheel. Examples of the state of the mobile robot 100 to be determined also include a mode state indicating whether the current mode is the autonomous movement mode or the user operation mode, or a state indicating whether the wagon 500 is loaded.

The determination of the traveling state can be made by the control computer 101 performing information processing, image processing, etc. based on the detection results from the sensors such as the sensor 105. The following description is given on the assumption that the determination is made in this manner. The sensors may have a function to make such a detection that the result of the detection indicates the determination result itself of the traveling state, or to determine the traveling state by performing information processing, image processing, etc. based on the sensing result. In that case, the sensors send the determination result to the control computer 101, and the control computer 101 can use the information received from the sensors as the determination result of the traveling state. The determination of the traveling state may be made by a determination unit provided separately from the control computer 101 that performs the light emission control.

Like the determination of the traveling state, the determination of the operating state can also be made by the control computer 101 performing information processing, image processing, etc. based on the detection results from the various sensors. The following description is given on the assumption that the determination is made in this manner. The sensors may have a function to make such a detection that the result of the detection indicates the determination result itself of the operating state, or to determine the operating state by performing information processing, image processing, etc. based on the sensing result. In that case, the sensors send the determination result of the operating state to the control computer 101, and the control computer 101 can use the information received from the sensors as the determination result of the operating state. The determination of the operating state may be made by a determination unit provided separately from the control computer 101 that performs the light emission control.

The mobile robot 100 can include a storage unit (not shown) configured to store the information indicating the traveling state or the operating state thus acquired, for example, in the control computer 101. The control computer 101 may determine the traveling state, the operating state, etc. based on information indicating the most recently stored traveling state, operating state, etc.

Based on the state of the mobile robot 100, the control computer 101 controls the first light-emitting unit 11 or both the first light-emitting unit 11 and the second light-emitting unit 12 to emit light in a predetermined light emission pattern associated with the state (step S12).

In step S12, for example, when the state of the mobile robot 100 is the autonomous movement mode and is normal, the control computer 101 can control the first light-emitting unit 11 and the second light-emitting unit 12 to emit light in a first light emission pattern exemplified as “normal (autonomous movement mode)” in FIG. 5.

When the state of the mobile robot 100 indicates any abnormality regardless of the mode, the control computer 101 can control the first light-emitting unit 11 and the second light-emitting unit 12 to emit light in a second light emission pattern exemplified as “abnormal” in FIG. 5.

When the state of the mobile robot 100 is the user operation mode and is normal, the control computer 101 can control the first light-emitting unit 11 and the second light-emitting unit 12 to emit light in a third light emission pattern exemplified as “normal (user operation mode)” in FIG. 5.

Although the states are classified into three and only three light emission patterns are exemplified according to the classification result, the states may also be classified into two, four, or more. Such a process can be repeated every time a change occurs in the detection results from the sensor 105 etc. that are used to determine the state of the mobile robot 100, or at predetermined intervals.

The light emission patterns to be used, such as the first to third light emission patterns and other light emission patterns that will be described later, may be stored in the form of, for example, a table in the control computer 101 so that they can be referred to during light emission control.

Next, the control computer 101 determines whether the wagon 500 is loaded onto the contact portion, that is, whether the wagon 500 is in contact with the contact portion (step S13). When the wagon 500 is not loaded, the process ends. Whether the wagon 500 is loaded can be determined as a state of the mobile robot 100 in step S11. Even if the determination is not made as a state of the mobile robot 100, the determination can be made at this time.

The control computer 101 determines, or acquires information as to, whether the wagon 500 etc. is loaded or whether an article is stored, based on information on the control to load the wagon 500 or based on the detection result from a weight sensor mounted on the lifting mechanism 140 or at a different position on the platform 110. In the case where the weight sensor is mounted, the control computer 101 can register the weight of each type of wagon or article as the transport object in advance, and can calculate from the combination of the registered weights how many of which wagons or articles are loaded. By this calculation, it is also possible to determine whether the wagon 500 is loaded with an article.

Alternatively, the control computer 101 may determine, or acquire information as to, whether the wagon 500 etc. is loaded, based on an image captured by a camera installed so as to include the lifting stage in its imaging range. Alternatively, the control computer 101 may determine, or acquire information as to, whether a transport object is being transported, based on information indicating a transport object set via the operation unit 130, a set or determined transport route, and current position information obtained from a position sensor etc. installed on the mobile robot 100. For the article placed in the wagon 500, the control computer 101 can determine or acquire the information indicating the article based on an image captured by the camera installed so as to include the lifting stage in its imaging range while the user was placing the article into the wagon 500. Alternatively, the control computer 101 may determine or acquire the information indicating the article being transported, based on information indicating an article set via the operation unit 130, a set or determined transport route, and current position information obtained from the position sensor etc. installed on the mobile robot 100. Transport object information that is the information indicating whether the wagon 500 is loaded and/or indicating the article may be acquired not only by these acquisition methods but also by other methods.

The mobile robot 100 can include a storage unit (not shown) configured to store the transport object information thus acquired, for example, in the control computer 101. The control computer 101 can determine whether the mobile robot 100 is transporting a transport object, including determination as to whether the wagon 500 is loaded, based on the stored transport object information.

When the wagon 500 is loaded onto and brought into contact with the contact portion, the control computer 101 controls the wagon-side light-emitting unit 513 to emit light in a light emission pattern corresponding to the predetermined light emission pattern of the first light-emitting unit 11 (step S14), and the process ends. For example, the control computer 101 can control the wagon-side light-emitting unit 513 to emit light in the same color as that in the light emission pattern of each state shown in FIG. 5. However, both the light emission patterns are not limited to those in the control to emit light in the same color. For example, exactly the same light emission pattern except the scale etc. may be adopted or different light emission patterns may be adopted as long as the predetermined light emission pattern is associated with the light emission pattern of the wagon-side light-emitting unit 513 in advance.

With such a configuration of the transport system according to the present embodiment, the following effects are attained when the mobile robot 100 transports an article using the wagon 500. That is, even when the state of the mobile robot 100 is displayed using the first light-emitting unit 11 provided around the contact portion that comes into contact with the wagon 500, this transport system can prevent the state of the mobile robot 100 from being less visible to the surroundings due to the presence of the wagon 500. In other words, this transport system can clearly notify the surroundings of the mobile robot 100 about the state of the mobile robot 100 even when the wagon 500 is loaded.

As described above, the state of the mobile robot 100 may include a transporting state indicating whether the mobile robot 100 is transporting an article. The predetermined light emission pattern and the light emission pattern of the wagon-side light-emitting unit 513 can thus be changed depending on the transporting state. It is thus possible to clearly notify the surroundings about whether the mobile robot 100 is transporting an article.

As described above, when the mobile robot 100 is transporting an article, the transporting state may include information indicating the article being transported in the wagon 500 by the mobile robot 100. The predetermined light emission pattern and the light emission pattern of the wagon-side light-emitting unit 513 can thus be changed depending on the article being transported. It is thus possible to clearly notify the surroundings about the article being transported by the mobile robot 100. The types of articles and the light emission patterns may have a one-to-one relationship. However, too many light emission patterns may confuse surrounding people. Therefore, the types of articles and the light emission patterns need not have a one-to-one relationship.

As described above, when the mobile robot 100 is transporting an article, the transporting state may include information indicating the type of the wagon 500 loaded on the contact portion. The type of the wagon 500 may indicate, for example, an attribute of the stored article. Taking the use of the mobile robot 100 in a hospital as an example, examples of the attribute may include medical equipment, specimens, medicines, and foods. The predetermined light emission pattern and the light emission pattern of the wagon-side light-emitting unit 513 can thus be changed depending on the type of the wagon 500. It is thus possible to clearly notify the surroundings about the type of the wagon 500 being transported by the mobile robot 100. The types of the wagon 500 and the light emission patterns may have a one-to-one relationship. However, too many light emission patterns may confuse surrounding people. Therefore, the types of the wagon 500 and the light emission patterns need not have a one-to-one relationship.

As described above, the first light-emitting unit 11 is a light-emitting unit mounted around the contact portion that may come into contact with a transport object when the transport object is loaded and transported. That is, the light-emitting unit is mounted on the mobile robot 100 in consideration of the portion on which a transport object is to be loaded, as exemplified by the positional relationship between the first light-emitting unit 11 and the lifting stage. The mobile robot 100 is easily visible from the surroundings even when the mobile robot 100 has a transport object loaded thereon, and is even more easily visible from the surroundings when the mobile robot 100 does not have any transport object loaded thereon. Even the first light-emitting unit 11 alone can therefore clearly notify the surroundings of the mobile robot 100 about whether the mobile robot 100 is transporting a transport object. In the case where light is emitted from the area around the contact portion as in this example and the wagon 500 is used for transport, the wagon 500 may have a mirror lower surface to make the light emission more visible to the surroundings of the mobile robot 100.

As described above, the second light-emitting unit 12 is a light-emitting unit mounted on or around a joystick device for operating the mobile robot 100. The light-emitting unit is mounted on the mobile robot 100 at a position high enough for the light-emitting unit to be easily visible from the operator or the surroundings, that is, at the operation position, as particularly exemplified by the second light-emitting unit 12. The mobile robot 100 can thus clearly notify the surroundings about whether the mobile robot 100 is transporting a transport object, even in a direction from which the loading position is less visible depending on the transport object such as the wagon 500.

Especially when the wagon 500 is used for transport, the inside of the wagon 500 is not visible from the operator. Therefore, the control computer 101 may perform control so as to indicate the presence or absence of a transport object in the wagon 500 by the difference in light emission pattern. The operator can thus be informed of useful information. In such control, the control computer 101 may change the predetermined light emission pattern based on the presence or absence of contents of the wagon 500.

The control for changing the light emission pattern can include control for changing at least one of the brightness, hue, saturation, and lightness of light that is emitted from any of the first light-emitting unit 11, the second light-emitting unit 12, and the wagon-side light-emitting unit 513. The control for changing the light emission pattern between the light-emitting units can also include, for example, control on the first light-emitting unit 11 and the second light-emitting unit 12 located away from each other or the first light-emitting unit 11 and the wagon-side light-emitting unit 513 located away from each other to emit light with different light emission parameters from each other. As used herein, the light emission parameter can be at least one of the following: brightness, hue, saturation, and lightness.

Light-emitting units that emit light simultaneously can be changed among the three light-emitting units. In one predetermined light emission pattern, light emission can be controlled so that light is emitted at all the positions of the first light-emitting unit 11, the second light-emitting unit 12, and the wagon-side light-emitting unit 513. In another predetermined light emission pattern, light emission can be controlled so that light is turned off at all the positions. In this way, the light emission patterns of the first light-emitting unit 11, the second light-emitting unit 12, and the wagon-side light-emitting unit 513 can be shown based on differences in ON and OFF of light emission.

In the first light-emitting unit 11 and the second light-emitting unit 12, a plurality of positions where light is synchronously emitted can be changed in order to change the light emission pattern in the mobile robot 100. In any case, the wagon-side light-emitting unit 513 is controlled to emit light in a light emission pattern corresponding to that of the first light-emitting unit 11.

Examples of such light emission patterns will be described. In a certain light emission pattern, only the first light-emitting unit 11 is controlled to emit light. In another light emission pattern, only the second light-emitting unit 12 is controlled to emit light. In still another light emission pattern, the first light-emitting unit 11 and the second light-emitting unit 12 are synchronized to emit light. Examples of synchronizing the first light-emitting unit 11 and the second light-emitting unit 12 to emit light include the example of “normal (autonomous movement mode)” and the example of “normal (user operation mode)” in FIG. 5. In an example in which the mobile robot 100 includes light-emitting units at three or more positions, a light emission pattern can be selected from many light emission patterns obtained from various combinations of the three or more light-emission units.

Examples of controlling the first light-emitting unit 11 and the second light-emitting unit 12 to emit light without synchronizing them include the example of “abnormal” in FIG. 5. In the example of “abnormal” in FIG. 5, the first light-emitting unit 11 and the second light-emitting unit 12 are shown hatched in opposite directions, but such hatching is merely for convenience and indicates that they are different from each other only in phase. In the case where the first light-emitting unit 11 and the second light-emitting unit 12 are controlled to emit light alternately, this example can be regarded as an example in which the timing to turn on the first light-emitting unit 11 and the timing to turn off the second light-emitting unit 12 are synchronized. As described above, the control computer 101 can control, as a certain light emission pattern, light emission of the first light-emitting unit 11 and the second light-emitting unit 12 so that they emit light at alternate timings, namely so that they emit light alternately.

The control computer 101 need not necessarily control light emission so that the first light-emitting unit 11 and the second light-emitting unit 12 emit light at alternate timings. The control computer 101 may control, as a certain light emission pattern, the first light-emitting unit 11 and the second light-emitting unit 12 to emit light out of phase. Light emission can thus be presented in various rhythms to the surroundings.

At a plurality of positions where light is synchronously emitted from the light-emitting units mounted on the mobile robot 100, light may be emitted in a light emission pattern having a mutually complementary relationship. The “light emission pattern having a mutually complementary relationship” can be a pattern in which the first light-emitting unit 11 and the second light-emitting unit 12 are controlled to emit light in colors that are easily visible when seen as a combination, such as a pattern in which the first light-emitting unit 11 and the second light-emitting unit 12 are controlled to emit light in complementary colors.

By using the various light emission patterns described above, the mobile robot 100 can notify the surroundings of the mobile robot 100 more clearly about the state of the mobile robot 100, and this effect can be obtained even more in combination with the light emission control on the wagon-side light-emitting unit 513.

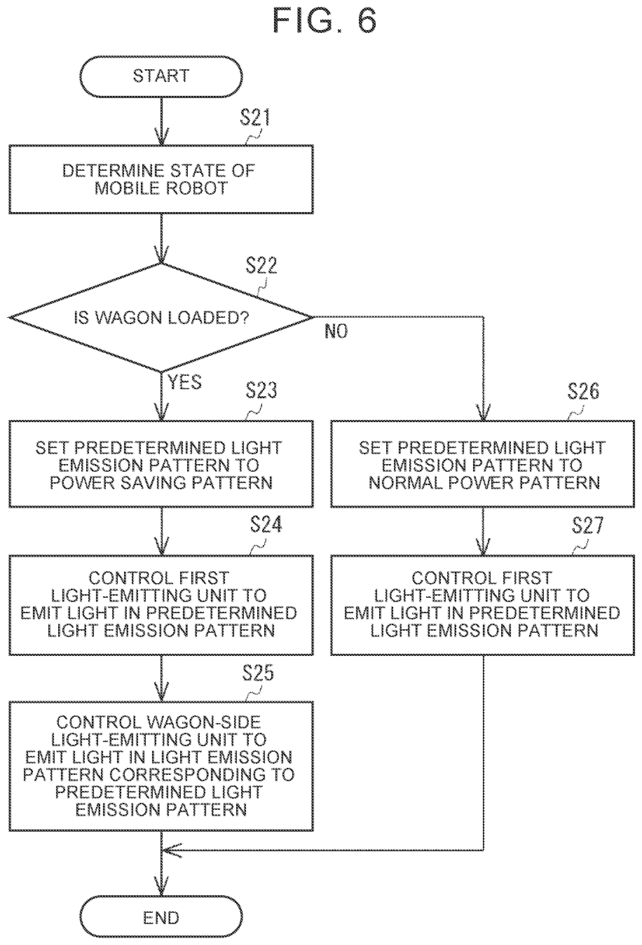

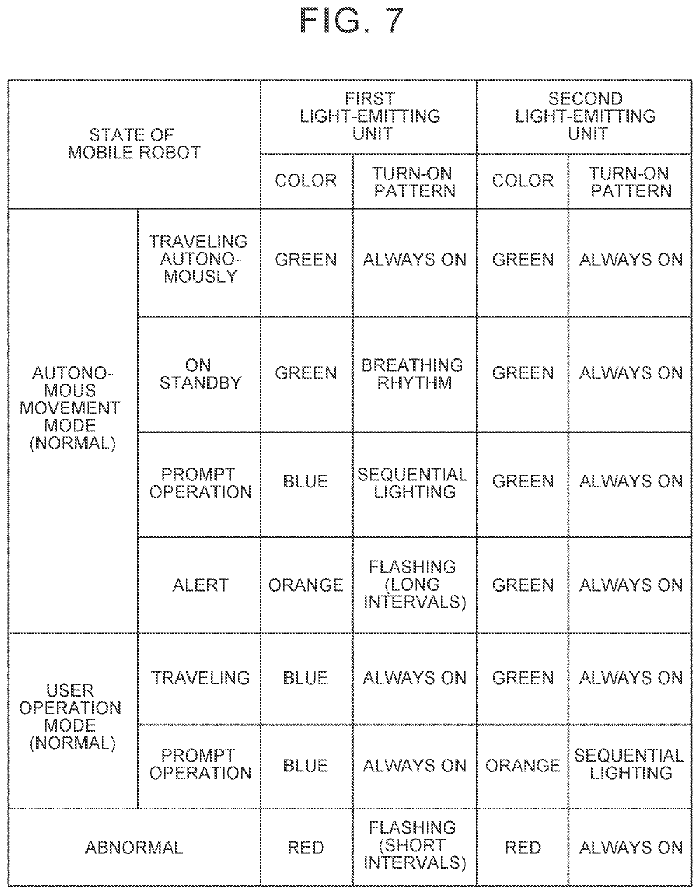

Next, another example of the light emission process that can be used in the present embodiment will be described with reference to FIGS. 6 and 7. FIG. 6 is a flowchart illustrating another example of the light emission process that is performed by the mobile robot 100. FIG. 7 shows another example of the light emission patterns that can be implemented by the mobile robot 100.

In this example, the control computer 101 performs pattern change control as one type of system control. The pattern change control is control for changing the predetermined light emission pattern of the first light-emitting unit 11 when the wagon 500 is loaded onto and brought into contact with the contact portion.

For example, the pattern change control may be control for changing the predetermined light emission pattern of the first light-emitting unit 11 when the wagon 500 is loaded onto and brought into contact with the contact portion to suppress the power consumption (reduce the power consumption) of the first light-emitting unit 11 compared to the case where the wagon 500 is not loaded onto the contact portion. That is, when the wagon 500 is loaded, the control computer 101 can suppress the power consumption by reducing the brightness of the predetermined light emission pattern so that it is not noticeable.

It is thus possible to clearly notify the surroundings about the state of the mobile robot 100 while suppressing unnecessary power consumption even when the mobile robot is transporting the wagon 500. The power consumption can be suppressed by reducing the brightness of light emission or emitting light only in part, namely reducing the light emission amount. At least when performing such control, the state of the mobile robot 100 is preferably presented in the light emission pattern of the second light-emitting unit 12. When such control is not performed, the second light-emitting unit 12 may be turned off.

For such control, the control computer 101 determines the state of the mobile robot 100 in the same manner as in step S11 of FIG. 4 (step S21). In step S21, whether the wagon 500 is loaded is also determined as a state of the mobile robot 100.

After step S21, the control computer 101 determines whether the wagon 500 is loaded on the mobile robot 100, based on the acquired state (step S22). When determination is made in step S22 that the wagon 500 is loaded, the control computer 101 sets the predetermined light emission pattern to a power saving pattern (step S23), and controls the first light-emitting unit 11 to emit light in the predetermined light emission pattern (step S24). At this time, the second light-emitting unit 12 may also be controlled to emit light. The control computer 101 then controls the wagon-side light-emitting unit 513 to emit light in a light emission pattern corresponding to the predetermined light emission pattern (step S25), and the process ends.

When determination is made in step S22 that the wagon 500 is not loaded, the control computer 101 sets the predetermined light emission pattern to a normal power pattern (step S26), and controls the first light-emitting unit 11 to emit light in the predetermined light emission pattern (step S27). Then, the process ends. In step S27, the second light-emitting unit 12 may also be controlled to emit light. In this case, the power consumption can be reduced by keeping the wagon-side light-emitting unit 513 off. Such a process can be repeated, for example, every time a change occurs in the detection results from the sensor 105 etc. that are used to determine the state of the mobile robot 100, or at predetermined intervals.

In steps S23, S26, the control computer 101 can select a light emission pattern and perform the light emission control in, for example, the following manner. As described above, for example, the brightness of light emission of the first light-emitting unit 11 in step S23 is controlled to be lower than that in step S26. An example will be given in which the process of FIG. 6 is repeated at predetermined intervals. For example, every time the process is repeated, that is, every predetermined period indicated by the predetermined interval, the control computer 101 refers to the correspondence between the states and the light emission patterns shown in FIG. 7, and controls the first light-emitting unit 11 and the second light-emitting unit 12 to emit light in a light emission pattern indicating the state and also controls the wagon-side light-emitting unit 513 to emit light.

In FIG. 7, the light emission patterns defined by the colors and turn-on patterns of light emission from the first light-emitting unit 11 and the second light-emitting unit 12 are exemplified for each of the cases of “autonomous movement mode (normal)”, “user operation mode (normal)”, and “abnormal” as in the example of FIG. 5. The turn-on pattern is selected from an always-on pattern in which light is constantly on, a flashing pattern in which light flashes at short intervals, and a flashing pattern in which light flashes at longer intervals. However, the intervals at which light flashes, that is, the flashing intervals, can also be set in three or more stages.

As can be seen from the example of the light emission patterns shown in FIG. 7, the second light-emitting unit 12 near the operation unit 130 and the stick portion 131 mainly indicates the mode when the mobile robot 100 is normal and an abnormality in the mobile robot 100, and the first light-emitting unit 11 indicates also the detailed operating state of the mobile robot 100 in the autonomous movement mode.

In FIG. 7, the case of “autonomous movement mode and normal” is divided into the following four cases as the detailed operating state in the autonomous movement mode. That is, FIG. 7 show an example of the light emission patterns for the following four cases: “traveling autonomously” indicating that the mobile robot 100 is moving autonomously, “on standby” indicating that the mobile robot 100 is under autonomous movement control but is stopped on standby, “prompt an operation” indicating a situation where the user is prompted to perform some kind of operation, and “alert” indicating a situation where some kind of alert is given to the user or the surroundings. The case of “on standby” can refer to, for example, the case where the mobile robot 100 is being charged with a charger or is waiting for an elevator. The case of “prompt an operation” can refer to, for example, the case where the mobile robot 100 has arrived at a transport destination. The case of “alert” can refer to, for example, the case where the lifting mechanism 140 is being raised or lowered or the case where the mobile robot 100 is approaching an intersection. The case of “traveling autonomously” refers to the other cases where the mobile robot 100 is traveling autonomously.

FIG. 7 also shows an example of the turn-on patterns including a “breathing rhythm” in which the brightness of light emission is changed in a rhythm similar to the rhythm of human breathing, and “sequential lighting” in which the light-emitting portions are turned on in a sequence. Examples of the sequential lighting include controlling the first light-emitting unit 11 to sequentially turn on its light-emitting portions around the lifting mechanism 140 and controlling the second light-emitting unit 12 to sequentially turn on its light-emitting portions around the stick portion 131. When controlling the first light-emitting unit 11 to sequentially turn on its light-emitting portions around the lifting mechanism 140, that is, in the sequential lighting, it is preferable to, for example, control the wagon-side light-emitting unit 513 to similarly sequentially turn on its light-emitting portions around the wagon 500.

The examples of the colors and turn-on patterns shown in FIG. 7 are applicable to such process examples as described with reference to FIGS. 4 and 5 and to other examples that will be described later.

When the wagon 500 is loaded, the control computer 101 can easily notify the surroundings by conversely increasing the brightness of the predetermined light emission pattern so that it is noticeable. In both the case of increasing the brightness and the case of reducing the brightness, the light emission pattern of the wagon-side light-emitting unit 513 can be changed depending on the predetermined light emission pattern, and the light emission pattern of the second light-emitting unit 12 can also be changed in the same manner as that of the first light-emitting unit 11. It is thus possible to notify the surroundings about the state of the mobile robot 100 more clearly even when the mobile robot 100 is transporting the wagon 500.

The pattern change control may be control for stopping light emission of the first light-emitting unit 11 when the wagon 500 is loaded onto and brought into contact with the contact portion. With such a configuration, when the wagon 500 is loaded, the light emission of the first light-emitting unit 11 that is less recognizable from the surroundings compared to the case where the wagon 500 is not loaded is stopped. Electric power can thus be used more efficiently.

Alternatively, the pattern change control can also be performed based on the sum of the power consumption of the first light-emitting unit 11 and the power consumption of the wagon-side light-emitting unit 513 when the wagon 500 is loaded onto and brought into contact with the contact portion. Specifically, the pattern change control may be control for changing the predetermined light emission pattern of the first light-emitting unit 11 to achieve a state in which a difference between the sum and the power consumption of the first light-emitting unit 11 when the wagon 500 is not loaded on the contact portion falls within a predetermined range. With such a configuration, it is possible to notify the surroundings about the state of the mobile robot 100 more clearly while efficiently using electric power even when the mobile robot 100 is transporting the wagon 500.

Even in such pattern change control, the light emission of the first light-emitting unit 11 may be stopped when the wagon 500 is loaded onto and brought into contact with the contact portion. With such a configuration, when the wagon 500 is loaded, the light emission of the first light-emitting unit 11 that is less recognizable from the surroundings compared to the case where the wagon 500 is not loaded is stopped. Electric power can thus be used more efficiently.

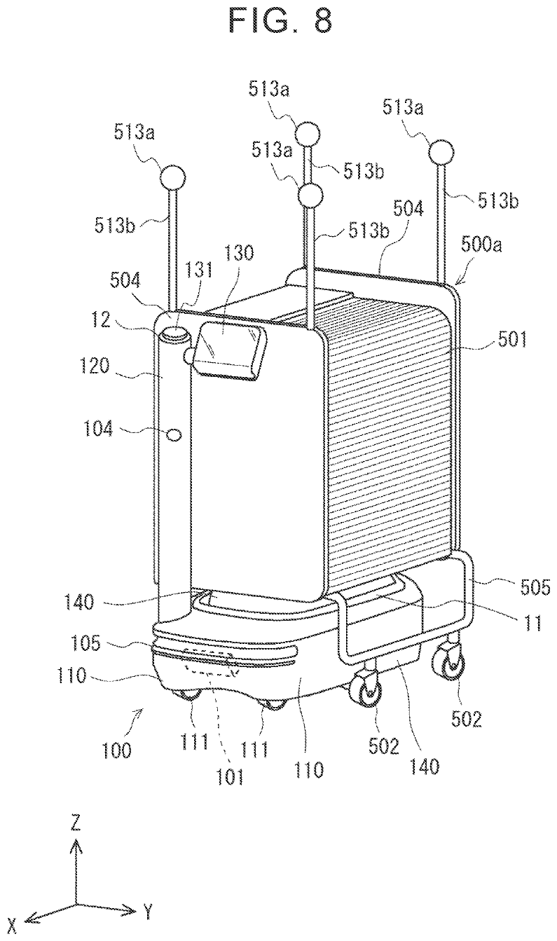

Next, an example of a wagon different from the wagon in FIG. 2 will be described with reference to FIG. 8. FIG. 8 is a perspective view showing how the mobile robot 100 in FIG. 1 transports a wagon in another configuration example.

A wagon 500a shown in FIG. 8 includes wagon-side light-emitting units 513a instead of the wagon-side light-emitting unit 513 of the wagon 500 in FIG. 2. The wagon-side light-emitting unit 513a is supported by a support member 513b attached to the upper surface of the side plate 504, specifically on the upper surface side of the support member 513b. FIG. 8 shows an example in which the wagon-side light-emitting unit 513a has a spherical light-emitting area extending horizontally in all directions. The portion of the wagon-side light-emitting unit 513a that is supported by the support member 513b does not emit light.

Electric power can be supplied to the wagon-side light-emitting unit 513a in the same manner as that for the wagon-side light-emitting unit 513 as long as a power supply cable is provided inside the support member 513b. The light emission control on the wagon-side light-emitting unit 513a can be performed basically in the same manner as that on the wagon-side light-emitting unit 513 as long as a cable for transmitting a control signal is provided inside the support member 513b. Although the light-emitting areas of the four wagon-side light-emitting units 513a exemplified in FIG. 8 are not spatially continuous, their light-emitting portions can be turned on sequentially. For example, the wagon-side light-emitting unit 513a to be turned on may be switched clockwise or counterclockwise when viewed from above the wagon 500a in such a manner that one wagon-side light-emitting unit 513a is turned on and then another adjacent wagon-side light-emitting unit 513a is turned on.

Since the wagon 500a includes the wagon-side light-emitting units 513a, the wagon-side light-emitting units 513a can be recognized from the surroundings more easily than in the case where the wagon-side light-emitting unit 513 is mounted on the lateral surface of the wagon 500 as shown in FIG. 2 or the case where the wagon-side light-emitting unit is mounted on the upper surface of the wagon 500.

In the example of FIG. 8, a total of four sets of the wagon-side light-emitting unit 513a and the support member 513b are provided near the four corners of the wagon 500a when viewed from the upper surface side of the body. However, it is sufficient that at least one set be provided. Even in the case where one set is provided, the light-emitting portions can be turned on sequentially as described above by switching the light-emitting portions of the one wagon-side light-emitting unit 513a clockwise or counterclockwise.

The support member 513b may be attached to a location other than the side plate 504 on the wagon 500a. The support member 513b may be removable from the wagon 500a, and the wagon-side light-emitting unit 513a may be removable from the support member 513b. The wagon-side light-emitting unit 513 in FIG. 2 may also be removable from the wagon 500.

In the example of FIG. 8, the wagon-side light-emitting unit 513a is the spherical light-emitting unit, but the shape is not limited to the spherical shape, and the light-emitting area of the wagon-side light-emitting unit 513a is not limited to the light-emitting area extending horizontally in all directions. For example, in the case where a plurality of wagon-side light-emitting units 513a is mounted on the wagon 500a as exemplified in FIG. 8, the light-emitting area of each wagon-side light-emitting unit 513a may be only the area outside the wagon 500a when viewed from the upper surface of the wagon 500a. Alternatively, each wagon-side light-emitting unit 513a may be configured to emit light in the area extending horizontally in all directions, and the light-emitting area may be adjusted so that light is emitted only in the area outside the wagon 500a.

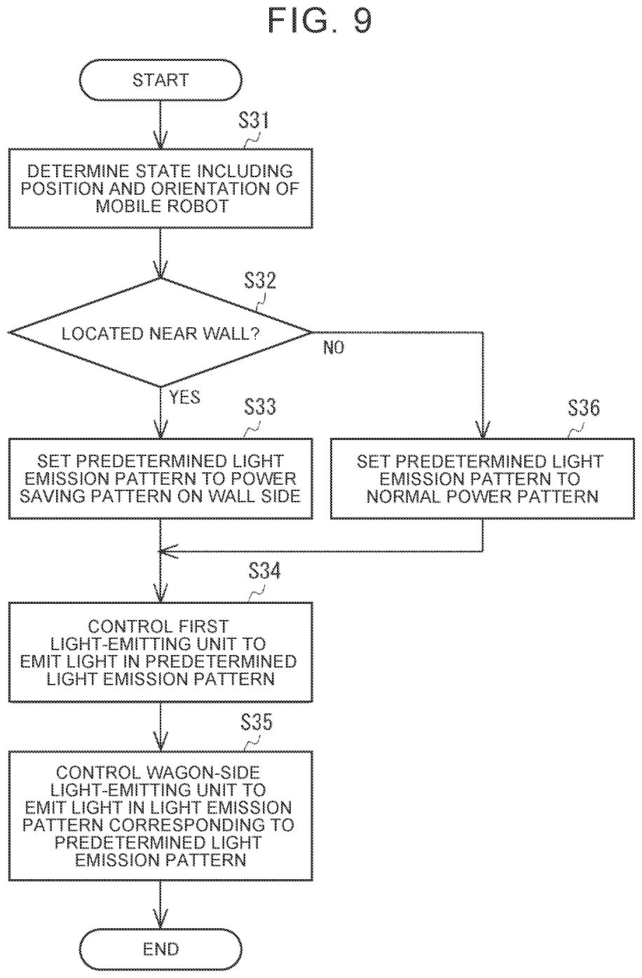

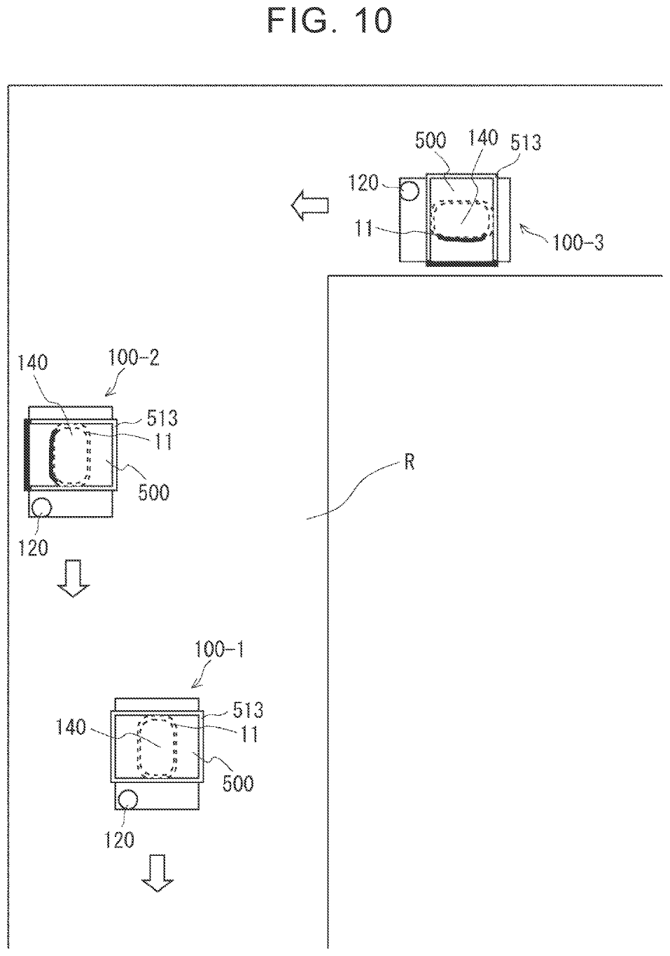

Next, still another example of the light emission process that can be used in the present embodiment will be described with reference to FIGS. 9 and 10. FIG. 9 is a flowchart illustrating still another example of the light emission process that is performed by the mobile robot 100. FIG. 10 is a schematic diagram showing a specific example of the light emission process in FIG. 9. Although an example will be given below in which the wagon 500 is transported, including the example described with reference to FIGS. 9 and 10, the process is also applicable to the case where the wagon 500a is transported.

In this example, when the mobile robot 100 is traveling near a wall, the control computer 101 performs, as one type of system control, control for suppressing the power consumption (reducing the power consumption) of the light-emitting portion on the wall side compared to a case where the mobile robot 100 is not traveling near the wall.

Specifically, when the mobile robot 100 is traveling near a wall, the control computer 101 performs, as one type of system control, pattern change control for changing the predetermined light emission pattern of the first light-emitting unit 11 to suppress the power consumption of the light-emitting portion of the first light-emitting unit 11 on the wall side. Alternatively, when the mobile robot 100 is traveling near a wall, the control computer 101 performs, as one type of system control, pattern change control for changing the predetermined light emission pattern of the first light-emitting unit 11 and the light emission pattern of the wagon-side light-emitting unit 513 to suppress the power consumptions of the light-emitting portions of the first light-emitting unit 11 on the wall side and the wagon-side light-emitting unit 513 on the wall side.

In any pattern change control, it is possible to suppress the power consumption by reducing the light emission amount of the light-emitting portion on the wall side when the mobile robot 100 is traveling near the wall. That is, such pattern change control allows the surroundings to be clearly notified about the state of the mobile robot 100 while efficiently using electric power even when the mobile robot 100 is transporting the wagon 500.

To simplify the description, such control will be described on the assumption that the wagon 500 is loaded. When the wagon 500 is not loaded, the various examples described above can be applied basically.

The control computer 101 determines the state of the mobile robot 100 in the same manner as in step S11 of FIG. 4 (step S31). In step S31, the position and orientation of the mobile robot 100 are also determined. The position and orientation of the mobile robot 100 can be determined by obtaining image information from a camera installed inside the facility, by obtaining image information from the camera 104, or based on position information acquired by a position information acquisition unit installed on the mobile robot 100. The position and orientation of the mobile robot 100 can also be determined based on any combination of these pieces of information, and map data can also be referred to.

After step S31, the control computer 101 determines whether the mobile robot 100 is located near a wall, that is, located in proximity to a wall, based on the acquired position and orientation of the mobile robot 100 (step S32). Whether the mobile robot 100 is located near a wall can be determined, for example, by determining the distance between the wall and a portion of the mobile robot 100 closest to the wall and comparing that distance with a predetermined threshold. The portion of the mobile robot 100 closest to the wall can be determined, for example, based on a camera image or based on position information of the mobile robot 100, information on the orientation of the mobile robot 100, and the shape of the surroundings of the mobile robot 100 that are acquired by sensors.

When determination is made in step S32 that the mobile robot 100 is located in proximity to a wall, the control computer 101 sets the predetermined light emission pattern to the power saving pattern at the light-emitting portion near the wall side (step S33), and controls the first light-emitting unit 11 to emit light in the predetermined light emission pattern (step S34). The control computer 101 then controls the wagon-side light-emitting unit 513 to emit light in a light emission pattern corresponding to the predetermined light emission pattern (step S35), and the process ends.

A simple specific example of steps S34, S35 will be given taking an example in which the mobile robot 100 travels along a passage R in FIG. 10. When the mobile robot 100 is in a position of “mobile robot 100-3” in FIG. 10, the brightness of light emission of the first light-emitting unit 11 and the brightness of light emission of the wagon-side light-emitting unit 513 at portions in black near a left wall in the traveling direction indicated by an outline arrow are reduced compared to a position of “mobile robot 100-1”. Electric power can thus be saved. When the mobile robot 100 is in a position of “mobile robot 100-2” in FIG. 10, the brightness of light emission of the first light-emitting unit 11 and the brightness of light emission of the wagon-side light-emitting unit 513 at portions in black near a right wall in the traveling direction indicated by the outline arrow are reduced compared to the position of “mobile robot 100-1”. Electric power can thus be saved. In step S34, the second light-emitting unit 12 may also be controlled to emit light.

When determination is made in step S32 that the mobile robot 100 is not located in proximity to a wall, the control computer 101 sets the predetermined light emission pattern to the normal power pattern (step S36), and performs the process of steps S34, S35. Then, the process ends. In this case, it is only necessary not to reduce the brightness of light emission of the first light-emitting unit 11 and the brightness of light emission of the wagon-side light-emitting unit 513 at any portions as in the case where the mobile robot 100 is in the position of “mobile robot 100-1” in FIG. 10. Such a process can be repeated, for example, when the position of the mobile robot 100 is changed or at predetermined intervals.

The control computer 101 may control the portion of the first light-emitting unit 11 near the wall to emit light to save electric power even in the situation where the wagon 500 is not loaded.

The above description illustrates an example in which the transport system is mainly composed of the mobile robot 100 and the wagon 500. However, the control system according to the present embodiment may be any system as long as it performs system control for controlling the transport system in the manner described above. This transport system may also include a server that is connectable to the mobile robot 100 via wireless communication. This server is a server that provides information for autonomous movement to the mobile robot 100. Since this server manages the mobile robot 100, it can also be referred to as “host management device”.

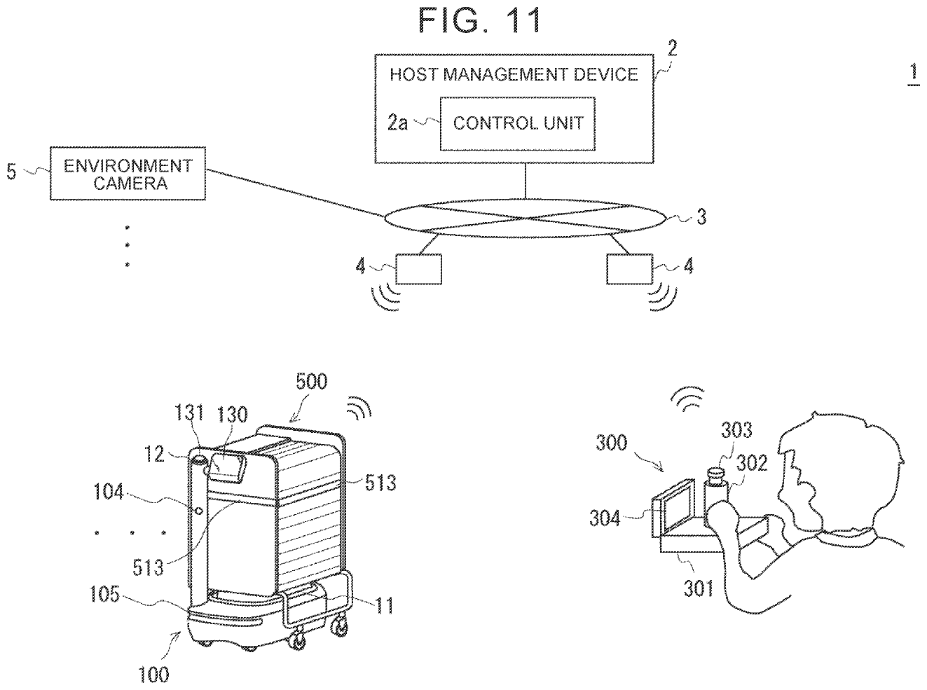

An example in which this transport system includes the mobile robot 100 and the host management device will be described below with reference to FIG. 11. FIG. 11 is a schematic diagram showing an example of the overall configuration of the transport system including the mobile robot 100.

As shown in FIG. 11, a transport system 1 includes the mobile robot 100, a host management device 2, a network 3, a communication unit 4, an environment camera 5, and user equipment 300. The transport system 1 is a system for transporting a transport object by the mobile robot 100, and includes a control system in this configuration example. In this example, the “control system” can refer to the mobile robot 100 and the host management device 2, or to the components of control systems provided in the mobile robot 100 and the host management device 2.

The mobile robot 100 and the user equipment 300 are connected to the host management device 2 via the communication unit 4 and the network 3. The network 3 is a wired or wireless local area network (LAN) or wide area network (WAN). The host management device 2 and the environment camera 5 are connected to the network 3 by wire or wireless. As can be seen from this configuration, each of the mobile robot 100, the host management device 2, and the environment camera 5 includes a communication unit. The communication unit 4 is, for example, a wireless LAN unit installed in each environment.

The communication unit 4 may be a general-purpose communication device such as a WiFi (registered trademark) router.

The host management device 2 is a device that is connectable to the mobile robot 100 by wireless communication and is a management system that manages a plurality of mobile robots 100. The host management device 2 can include a control unit 2a for controlling the mobile robots 100. The control unit 2a can be implemented by, for example, integrated circuitry, and can be implemented by, for example, a processor such as an MPU or a CPU, a working memory, and a nonvolatile storage device. The function of the control unit 2a can be performed by the storage device storing a control program to be executed by the processor and the processor loading the program into the working memory and executing the program. The control unit 2a can be referred to as “control computer”.

The transport system I can efficiently control the mobile robots 100 while autonomously moving the mobile robots 100 in the autonomous movement mode inside a predetermined facility. The “facility” can refer to various types of facility including medical and welfare facilities such as hospitals, rehabilitation facilities, nursing homes, and residential care homes for the elderly, commercial facilities such as hotels, restaurants, office buildings, event venues, and shopping malls, and other complex facilities.

In order to perform such efficient control, a plurality of environment cameras 5 can be installed inside the facility. Each environment camera 5 acquires an image of the range in which a person or the mobile robot 100 moves, and outputs image data representing the image. This image data may be still image data or moving image data. In the case of the still image data, the still image data is obtained at each imaging interval. In the transport system 1, the host management device 2 collects the images acquired by the environment cameras 5 and information based on these images. As for the images that are used to control the mobile robots 100, the images etc. acquired by the environment cameras 5 may be directly sent to the mobile robots 100, and in the user operation mode, may be sent to the user equipment 300 directly or via the host management device 2. The environment cameras 5 can be installed as surveillance cameras in passages inside the facility or at entrances to the facility.

The host management device 2 can determine, for each transport request, the mobile robot 100 to perform the transport task, and can send to the determined mobile robot 100 an operation command to perform the transport task. The mobile robot 100 can autonomously move from a transport origin to a transport destination according to the operation command. In this case, a transport route etc. may be determined by any method.

For example, the host management device 2 assigns the transport task to the mobile robot 100 located at or near the transport origin. Alternatively, the host management device 2 assigns the transport task to the mobile robot 100 heading toward or near the transport origin. The mobile robot 100 to which the task has been assigned moves to the transport origin to pick up a transport object.

The user equipment 300 is a device that remotely operates the mobile robot 100 via the host management device 2 or directly in the user operation mode. The user equipment 300 can have a communication function for this remote operation, and can include a display unit 304. Various types of terminal equipment such as a tablet computer and a smartphone can be used as the user equipment 300. The user equipment 300 can also receive a switching operation to switch between the user operation mode and the autonomous movement mode. When this switching operation is performed, the mode of the mobile robot 100 can be switched via the host management device 2.

An example will be given below in which the user equipment 300 includes a joystick device. The user equipment 300 can include a stick portion 302 and a button 303 as part of the joystick device in addition to a body 301. The joystick device is a device that is operated to move the mobile robot 100 in a direction intended by the user in the user operation mode. The joystick device can receive a directional operation when the stick portion 302 is tilted in a direction in which the user wants the mobile robot 100 to move. The joystick device can also be controlled to perform a select operation by depressing the button 303. The button 303 can also be used to perform the switching operation described above. The button 303 may be configured to serve as an emergency stop button when it is depressed for a predetermined period. In the case where a plurality of operations is assigned to the button 303, predetermined periods associated with the operations only need to be set for the button 303. In the case where the user equipment 300 includes a joystick device, the user can perform similar operations even when the mobile robot 100 does not include a joystick device. It is assumed that, in the configuration in which the transport system 1 manages a plurality of mobile robots 100, the mobile robot 100 to be remotely operated can be selected by the user equipment 300 in the user operation mode.

The display unit 304 can display an image indicated by image data received from the camera 104 of the mobile robot 100 and an image indicated by image data received from the environment camera 5 located around the mobile robot 100. This allows the user to operate the mobile robot 100 using the stick portion 302 and the button 303.

The user equipment 300 can function as a device for sending a transport request etc. to the host management device 2. This transport request can include information indicating a transport object.

The control system in the transport system I can perform the following determination process at least when the host management device 2 is unable to communicate with the mobile robot 100. When the host management device 2 is unable to communicate with the mobile robot 100, the control system can perform a determination process for determining the state of the mobile robot 100 based on an image of the mobile robot 100 captured by the environment camera 5, namely based on the light emission pattern shown by the image. This image can be an image captured by a camera of another mobile robot included in the transport system 1, instead of or in addition to the image captured by the environment camera 5.

In the control system of the transport system 1 having such a configuration, the host management device 2 can determine the state of the mobile robot 100 even when the mobile robot 100 and the host management device 2 are unable to communicate with each other.

Accordingly, for example, when the mobile robot 100 that is unable to communicate is in an abnormal state, an instruction to, for example, collect or inspect the mobile robot 100 can be given to the user, and the user can perform such work according to the instruction. For example, when the mobile robot 100 that is unable to communicate has a transport object loaded thereon or has an urgent transport object loaded thereon, an instruction to, for example, collect the transport object and deliver it to a transport destination can be given to the user, and the user can perform such work according to the instruction.

A method by which the mobile robot 100 acquires transport object information as a state of the mobile robot 100 will be described. In the transport system 1 as well, the mobile robot 100 can acquire transport object information by the method described with reference to FIG. 1 etc.

As another acquisition method, the mobile robot 100 can determine transport object information from an image captured by the environment camera 5 and sent to the mobile robot 100 directly or via the host management device 2. An image captured by a camera of another mobile robot rather than the environment camera 5 may be used for the determination. In other words, the control computer 101 can determine transport object information based on an image captured by a camera installed in a facility where the mobile robot 100 is used, as exemplified by the environment camera 5 or the camera of another mobile robot. The control unit 2a of the host management device 2 can also make such a determination. In this case, transport object information is preferably sent in advance to the mobile robot 100 in case of interruption of wireless communication with the host management device 2.

As an acquisition method other than the above methods, the mobile robot 100 can acquire transport object information from the host management device 2. In the case where the mobile robot 100 acquires transport object information from the host management device 2, the host management device 2 only needs to update the transport object information according to the transport status. For example, the host management device 2 can update transport object information by receiving information indicating the current position of the mobile robot 100 or information indicating the transport status of the transport object from the mobile robot 100 or by determining transport object information from an image obtained by the environment camera 5.

Information indicating the state of the mobile robot 100 other than transport object information can be similarly acquired by various methods. Even in the configuration in which the mobile robot 100 acquires transport object information or other information indicating the state from the host management device 2, the mobile robot 100 can acquire the information before communication with the host management device 2 is interrupted. Therefore, the mobile robot 100 can perform the light emission control according to the information obtained before communication is interrupted.

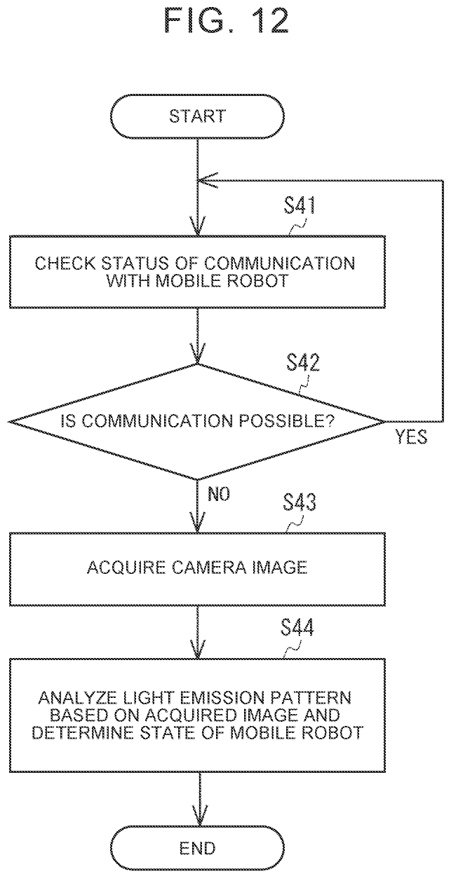

An example of a process that is performed by the host management device 2 in the transport system I will be described with reference to FIG. 12. FIG. 12 is a flowchart illustrating an example of the process that is performed by the host management device 2 in the transport system 1 in FIG. 11.

First, the control unit 2a of the host management device 2 monitors the

communication unit (not shown) to check the status of communication with the mobile robot 100 (step S41), and determines whether communication with the mobile robot 100 is possible (step S42). When the control unit 2a determines that communication with the mobile robot 100 is possible, the process returns to step S41 and continues to monitor the communication unit. When the control unit 2a determines that communication with the mobile robot 100 is not possible, the control unit 2a acquires an image from a camera (step S43). This camera can be the environment camera 5, the camera installed in another mobile robot traveling near the position where communication with the mobile robot 100 is interrupted, or both of them.

The control unit 2a then analyzes the light emission pattern of the mobile robot 100 based on the acquired image and determines the state of the mobile robot 100 (step S44), and the process ends. The control unit 2a may be configured to obtain information indicating the state from an image using a learning model obtained through machine learning, when analyzing the light emission pattern and determining the state.

As described above, even when communication between the mobile robot 100 and the host management device 2 is not possible, the host management device 2 of the control system of the transport system 1 can determine the state of the mobile robot 100 presented by the light emission pattern of the mobile robot 100.

Even in a configuration in which the transport system does not include the host management device 2, the transport system can include the environment camera 5 that can wirelessly communicate with the mobile robot 100. Even in such a configuration example, transport object information or other information indicating the state can be similarly determined from an image obtained from the environment camera 5.

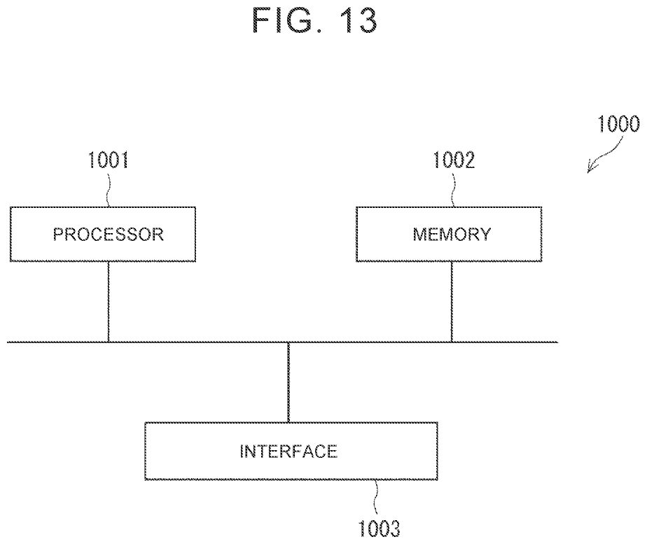

Each of the devices such as the control computer 101 of the mobile robot 100, the host management device 2, and the user equipment 300 according to the above embodiment can have, for example, the following hardware configuration. FIG. 13 shows an example of the hardware configuration of each device.

A device 1000 shown in FIG. 13 can include a processor 1001, a memory 1002, and an interface 1003. The interface 1003 can include, for example, a communication interface and an interface with a drive unit, a sensor, an input and output device, etc. as necessary for the individual device.

The processor 1001 may be, for example, an MPU, a CPU, or a graphics processing unit (GPU). The processor 1001 may include a plurality of processors. The memory 1002 is, for example, a combination of a volatile memory and a nonvolatile memory. The functions of each device are implemented by the processor 1001 reading a program stored in the memory 1002 and executing the program while sending and receiving necessary information via the interface 1003.

The program includes a group of instructions (or software codes) for causing a computer to perform one or more of the functions described in the embodiment when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory technologies, a compact disc read-only memory (CD-ROM), a digital versatile disc (DVD), a Blu-ray (registered trademark) disc, and other optical disc storages, and a magnetic cassette, a magnetic tape, a magnetic disk storage, and other magnetic storage devices. The program may be transmitted on a transitory computer-readable medium or a communication medium. Examples of the transitory computer-readable medium or the communication medium include, but are not limited to, propagating signals in electrical, optical, acoustic, or other forms.

The present disclosure is not limited to the embodiment described above. and may be modified as appropriate without departing from the spirit and scope of the present disclosure.

What is claimed is:

1. A control system comprising one or more processors configured to perform system control for controlling a system including a mobile robot configured to move autonomously and transport a transport object, wherein
the mobile robot includes a contact portion which comes into contact with a transport box configured to store the transport object when loading and transporting the transport box, and a first light-emitting unit provided around the contact portion and configured to emit light in a predetermined light emission pattern associated with a state of the mobile robot,
the transport box includes a box-side light-emitting unit which is a light-emitting unit provided on the transport box, and
the system control includes control on the box-side light-emitting unit to emit light in a light emission pattern corresponding to the predetermined light emission pattern of the first light-emitting unit when the transport box is loaded on the contact portion.

2. The control system according to claim 1, wherein the system control includes pattern change control for changing the predetermined light emission pattern of the first light-emitting unit when the transport box is loaded on the contact portion.

3. The control system according to claim 2, wherein in the pattern change control, the predetermined light emission pattern of the first light-emitting unit is changed when the transport box is loaded on the contact portion to reduce a power consumption of the first light-emitting unit compared to a case where the transport box is not loaded on the contact portion.

4. The control system according to claim 2, wherein in the pattern change control, the predetermined light emission pattern of the first light-emitting unit is changed when the transport box is loaded on the contact portion to achieve a state in which a difference falls within a predetermined range, the difference being a difference between a sum of a power consumption of the first light-emitting unit and a power consumption of the box-side light-emitting unit and a power consumption of the first light-emitting unit when the transport box is not loaded on the contact portion.

5. The control system according to claim 3, wherein in the pattern change control, light emission of the first light-emitting unit is stopped when the transport box is loaded on the contact portion.

6. The control system according to claim 1, wherein the box-side light-emitting unit is provided on at least one of a lateral surface side or an upper surface side of the transport box.

7. The control system according to claim 1, wherein the system control includes pattern change control for changing the predetermined light emission pattern of the first light-emitting unit or both the predetermined light emission pattern and the light emission pattern of the box-side light-emitting unit when the mobile robot is traveling near a wall to reduce a power consumption of a light-emitting portion of the first light-emitting unit on a wall side or both the power consumption of the light-emitting portion of the first light-emitting unit on the wall side and a power consumption of a light-emitting portion of the box-side light-emitting unit on the wall side compared to a case where the mobile robot is not traveling near the wall.

8. The control system according to claim 1, wherein the state of the mobile robot includes a transporting state indicating whether the mobile robot is transporting the transport object.

9. The control system according to claim 8, wherein the transporting state includes, when the mobile robot is transporting the transport object, information indicating the transport object in the transport box being transported by the mobile robot.

10. The control system according to claim 8, wherein the transporting state includes, when the mobile robot is transporting the transport object, information indicating a type of the transport box loaded on the contact portion.

11. The control system according to claim 1, wherein the transport box is configured to receive electric power supplied from the mobile robot when the transport box is loaded on the contact portion.

12. A control method comprising performing system control for controlling a system including a mobile robot configured to move autonomously and transport a transport object, wherein
the mobile robot includes a contact portion which comes into contact with a transport box configured to store the transport object when loading and transporting the transport box, and a first light-emitting unit provided around the contact portion and configured to emit light in a predetermined light emission pattern associated with a state of the mobile robot,
the transport box includes a box-side light-emitting unit which is a light-emitting unit provided on the transport box, and
the system control includes control on the box-side light-emitting unit to emit light in a light emission pattern corresponding to the predetermined light emission pattern of the first light-emitting unit when the transport box is loaded on the contact portion.

13. The control method according to claim 12, wherein the system control includes pattern change control for changing the predetermined light emission pattern of the first light-emitting unit when the transport box is loaded on the contact portion.

14. The control method according to claim 13, wherein in the pattern change control, the predetermined light emission pattern of the first light-emitting unit is changed when the transport box is loaded on the contact portion to reduce a power consumption of the first light-emitting unit compared to a case where the transport box is not loaded on the contact portion.

15. The control method according to claim 13, wherein in the pattern change control, the predetermined light emission pattern of the first light-emitting unit is changed when the transport box is loaded on the contact portion to achieve a state in which a difference falls within a predetermined range, the difference being a difference between a sum of a power consumption of the first light-emitting unit and a power consumption of the box-side light-emitting unit and a power consumption of the first light-emitting unit when the transport box is not loaded on the contact portion.

16. The control method according to claim 14, wherein in the pattern change control, light emission of the first light-emitting unit is stopped when the transport box is loaded on the contact portion.

17. The control method according to claim 12, wherein the box-side light-emitting unit is provided on at least one of a lateral surface side or an upper surface side of the transport box.

18. The control method according to claim 12, wherein the system control includes pattern change control for changing the predetermined light emission pattern of the first light-emitting unit or both the predetermined light emission pattern and the light emission pattern of the box-side light-emitting unit when the mobile robot is traveling near a wall to reduce a power consumption of a light-emitting portion of the first light-emitting unit on a wall side or both the power consumption of the light-emitting portion of the first light-emitting unit on the wall side and a power consumption of a light-emitting portion of the box-side light-emitting unit on the wall side compared to a case where the mobile robot is not traveling near the wall.

19. The control method according to claim 12, wherein the state of the mobile robot includes a transporting state indicating whether the mobile robot is transporting the transport object.

20. The control method according to claim 19, wherein the transporting state includes, when the mobile robot is transporting the transport object, information indicating the transport object in the transport box being transported by the mobile robot.
